(19) United States
(12) Patent Application Publication
(10) Pub. No.: US 2008/0065733 A1
(43) Pub. Date: Mar. 13, 2008

(54) LOG TRANSFER DEVICE AND RECORDING MEDIUM

(76) Inventor: Fumihiro Umetsu, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/851,063

(22) Filed: Sep. 6, 2007

(30) Foreign Application Priority Data
Sep. 12, 2006 (JP) 2006-247242
May 8, 2007 (JP) 2007-123630

(51) Int. Cl. G06F 7/32

(52) U.S. Cl. 709/206

(57) ABSTRACT

A log transfer device is disclosed that transfers a log information item to an external device connected via a predetermined network. The log transfer device includes a storage unit that stores the log information item; a log control unit that, if the log information item is not one that causes generation of another log information item due to transfer to the external device, sends a log change report; and a log transfer unit that, in response to reception of the log change report, reads out the log information item from the storage unit and transfers the read log information item to the external device.

### BACKGROUND OF THE INVENTION

1. Field of the Invention

The present invention generally relates to a log transfer device and a recording medium storing a log transfer program, and particularly relates to a log transfer device that transfers log information to an external device and a recording medium storing a log transfer program therefor.

2. Description of the Related Art

There has been a technology that transfers log information, including information about a device, information about jobs executed by a device, and information about communications with external devices, to an external device such as a log server through a predetermined network such as a local area network (LAN) and the Internet, and thus the log information is managed.

In recent years, along with rapid increase of the types of log information, it has become common to manage not only log information about jobs executed by a device, but also log information about communication results (see, for example, Japanese Registered Patent No. 3679616 and Japanese Patent Laid-Open Publication No. 2006-107217).

Among the log information types, there are a communication log that is generated upon transfer of an information item to an external device and indicates the start or the end of a communication for the information transfer and a log-transfer-result-log that indicates the result of a log transfer. If a device transfers to an external device such a communication log or a transfer-result-log to an external device, because these log information items are generated based on a request from the device, the result is returned as a response. Thus, due to the transfer of the communication log or the log-transfer-result log about the transfer of the communication log, another communication log or another log-transfer-result log is generated.

Therefore, although there is actually no log information item that should be transferred, the device enters into an endless loop of transferring log information items, resulting in waste of device resources. In addition, the device generates unnecessary communications, resulting in waste of network resources.

### SUMMARY OF THE INVENTION

In view of the foregoing, the present invention is directed to provide a log transfer device capable of efficiently transferring log information that should be transferred while preventing waste of resources, a log transfer program therefor, and a computer-readable medium storing the log transfer program.

According to an aspect of the present invention, there is provided a log transfer device that transfers a log information item to an external device connected via a predetermined network. The log transfer device includes a storage unit that stores the log information item; a log control unit that, if the log information item is not one that causes generation of another log information item due to transfer to the external device, sends a log change report; and a log transfer unit that, in response to reception of the log change report, reads out the log information item from the storage unit and transfers the read log information item to the external device.

Embodiments of the present invention include a method, a device, a system, a computer program, a recording medium, and a data structure to which a component or an arbitrary combination of components of the present invention is applied.

Embodiments of the present invention provide a log transfer device capable of efficiently transferring log information that should be transferred while preventing waste of resources, a log transfer program therefor, and a computer-readable medium storing the log transfer program.

### BRIEF DESCRIPTION OF THE DRAWINGS

FIG. 1 is a block diagram showing a configuration of a log transfer system according to an embodiment of the present invention;

FIG. 2 is a diagram illustrating processing blocks of a log transfer system;

FIG. 3 is a diagram illustrating a relationship between processing blocks of a log transfer system;

FIG. 4 is a diagram used to describe an advantageous effect of a log transfer system of an embodiment of the present invention;

FIG. 5 is a sequence diagram showing a process of printing a PDL file transferred from a client PC;

FIG. 6 is a flowchart showing an example of processing by an SFTP client;

FIG. 7 is a flowchart showing an example of processing by an SFTP server;

FIG. 8 is a flowchart showing an example of processing by a printer image drawing module;

FIG. 9 is a flowchart showing an example of processing by a plotter;

FIG. 10 is a flowchart showing an example of processing by an LCS;

FIG. 11 is a flowchart showing an example of a log registration process;

FIG. 12 is a flowchart showing an example of an LCS setting value change process;

FIG. 13 is a flowchart showing an example of a log acquisition process;

FIG. 14 is a flowchart showing an example of a log search process;

FIG. 15 is a flowchart showing an example of a transferred-log report reception process;

FIG. 16 is a flowchart showing an example of processing by a log transfer module;

FIG. 17 is a flowchart showing an example of a log change report reception process;

FIG. 18 is a chart showing a transition of the transfer status of a log transfer module;

FIG. 19 is a flowchart showing an example of a periodic transfer instruction reception process;

FIG. 20 is a flowchart showing an example of a log search result reception process;

FIG. 21 is a flowchart showing an example of a log reception process;

FIG. 22 is a flowchart showing an example of a log transfer result reception process;

FIG. 23 is a sequence diagram showing a process of changing an LCS setting value using a client PC;

FIG. 24 is a flowchart showing an example of processing by an https client;

FIG. 25 is a chart showing a transition of the communication status of an https client;

FIG. 26 is a flowchart showing an example of processing by an https server of a device;

FIG. 27 is a flowchart showing an example of a server certificate request reception process;

FIG. 28 is a flowchart showing a transition of the communication status of an https server;

FIG. 29 is a flowchart showing an example of a transferred-data reception process;

FIG. 30 is a flowchart showing an example of an LCS setting value change response reception process;

FIG. 31 is a flowchart showing an example of a communication-end reception process;

FIG. 32 is a sequence diagram showing a process of periodically transferring log information items from a device to a log server;

FIG. 33 is a flowchart showing an example of processing by a timer;

FIG. 34 is a flowchart showing an example of processing by an https client of a device;

FIG. 35 is a flowchart showing an example of a log-transfer-start reception process;

FIG. 36 is a chart showing a transition of the transmission status of an https client;

FIG. 37 is a flowchart showing an example of a log reception process;

FIG. 38 is a flowchart showing an example of a data transfer response reception process;

FIG. 39 is a flowchart showing an example of a server certificate reception process;

FIG. 40 is a flowchart showing an example of processing by an https server of a log server;

FIG. 41 is a chart showing a transition of the communication status of an https server;

FIG. 42 is a sequence diagram showing a process of sequentially transferring log information items from a device to a log server;

FIGS. 43 through 46 are conceptual diagrams each used to explain attributes of a log information item;

FIG. 47 is a table showing log types and settings specifying whether to issue a log change report;

FIG. 48 is a conceptual diagram showing a Web screen for LCS setting value change; and

FIG. 49 is a table showing log management attributes.

### DETAILED DESCRIPTION OF THE PREFERRED EMBODIMENT

A preferred embodiment of the present invention is described below with reference to the accompanying drawings. Although an image forming apparatus such as a multifunction machine is used as an example of a device in the following embodiment, other devices may also be used that transfer log information to an external device. Although a log server is used as an example of an external device in the following embodiment, other external devices may also be used that receive log information transferred from a device.

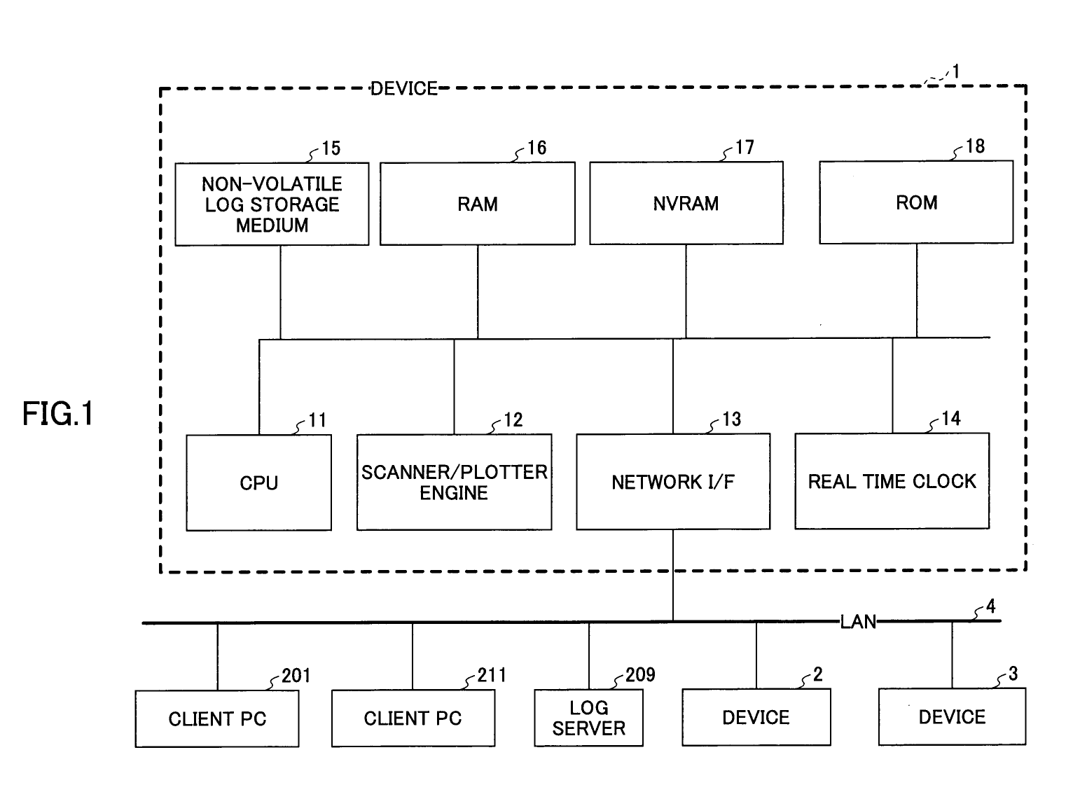

FIG. 1 shows a configuration of a log transfer system according to an embodiment of the present invention. The log transfer system of FIG. 1 comprises devices 1 through 3, client PCs 201 and 211, a log server 209, and a LAN 4 as an example of a predetermined network interconnecting them.

The device 1 comprises a CPU 11, a scanner/plotter engine 12, a network I/F 13, a real time clock 14, a non-volatile log storage medium (HDD) 15, a RAM 16, an NVRAM 17, and a ROM 18.

The HDD 15 holds attributes of log information. The RAM 16 is a working memory used for processing, and holds variables. If the device 1 is not provided with the HDD 15, the RAM 16 holds attributes of log information. The NVRAM 17 holds setting values of a log control service and a log transfer module (both described below), a log ID to be assigned to a new log, and other setting values. The setting values of the log control service indicate, e.g., ON/OFF of logging for each type of log information. The setting value of the log transfer module indicates the transfer mode of either periodic transfer or sequential transfer.

The setting values of the log control service and the log transfer module can be changed on a Web screen, for example. For example, a user can change the setting values of the log control service and the log transfer module on a Web screen of the client PC 211.

The log server 209 receives a log information item from the device 1. The client PC 201 transfers a PDL file generated by a printer driver using an SFTP (Secure FTP). The devices 2 and 3 have the same configuration as the device 1.

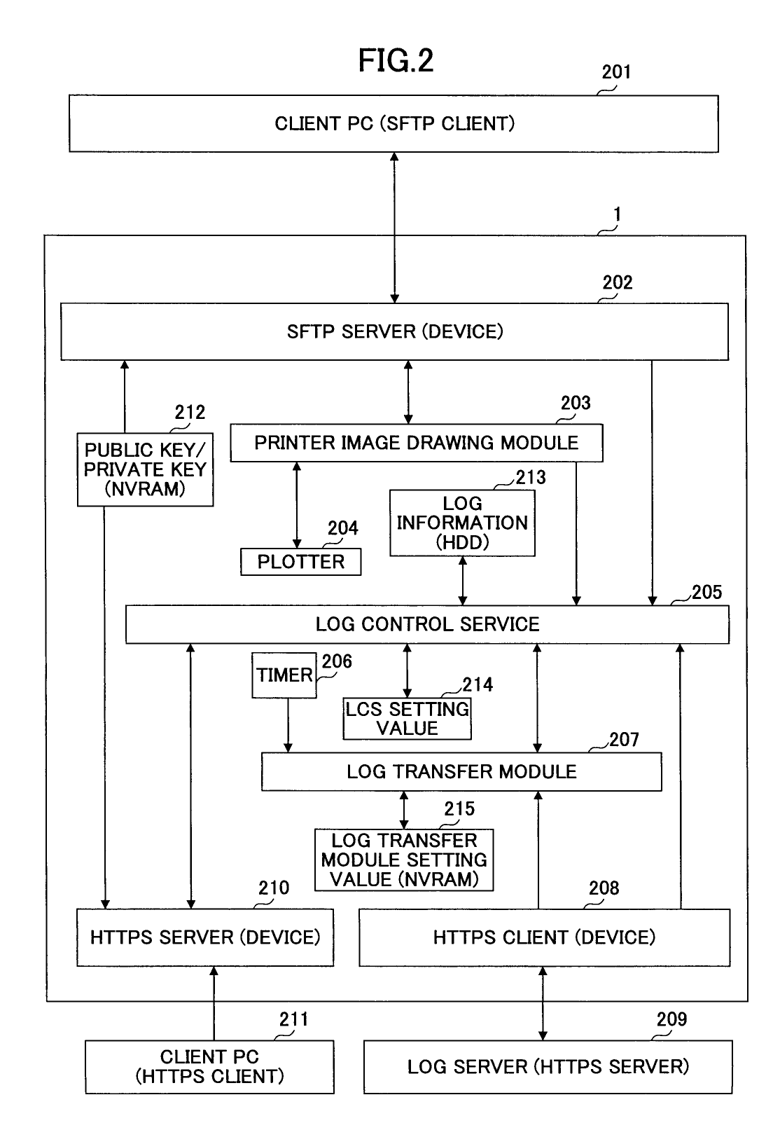

FIG. 2 is a diagram illustrating processing blocks of the log transfer system, wherein the device 1, the client PC 201, the log server 209, and the client PC 211 are shown.

The device 1 includes an SFTP server 202, a printer image drawing module 203, a plotter 204, a log control service (hereinafter referred to simply as an LCS) 205, a timer 206, a log transfer module 207, an https client 208, an https server 210, a public key/private key 212, log information 213, and setting values (LCS setting values) 214 of the LCS 205.

The SFTP server 202 communicates with the SFTP client of the client PC 201. The https server 210 communicates with an https client of the client PC 211. The https client 208 communicates with an https server of the log server 209.

The public key/secret key 212 is held in, e.g., the NVRAM 17, and is transferred from the NVRAM 17 to the SFTP server 202 and the https server 210 for encrypted communications. The log information 213 is held in the HDD 15. The LCS setting values 214 are held in, e.g., the NVRAM 17. A setting value (log transfer module setting value) 215 of the log transfer module 207 is also held in, e.g., the NVRAM 17.

The LCS 205 receives a log information item generated in response to a communication made from the SFTP server 202, the https server 210, or the https client 208, and records the log information item into the HDD 15. The LCS 205 also receives a log information item generated in response to, e.g., execution of a printing process.

The timer 206 reports, if the transfer mode is periodic transfer, the timing of executing a periodic transfer to the log transfer module 207. The log transfer module 207 transfers a log information item from the https client 208 to the https server of the log server 209 in response to reception of a log change report from the LCS 205. The log transfer module 207 sends a result of transfer of a log information item to the LCS 205 as another log information item. The log change report is for reporting, if a new log information item is recorded in the LCS 205, to the log transfer module 207 that the content of the log information has been changed (a new log information item has been recorded).

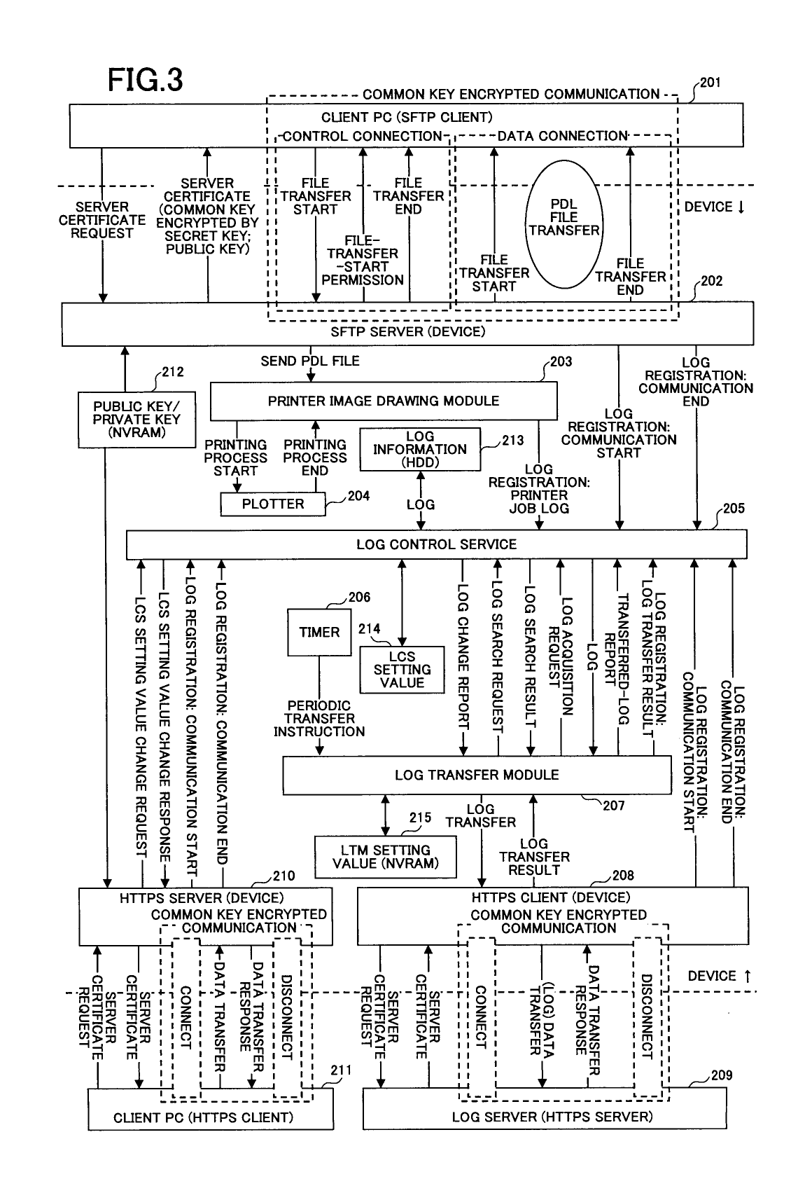

FIG. 3 is a diagram showing a relationship between the processing blocks of the log transfer system. In FIG. 3, a relationship between the processing blocks of FIG. 2 is illustrated based on the flow of various requests, reports, responses, data, and files exchanged among the processing blocks. The requests, reports, responses, data, and files exchanged among the processing blocks are described below in greater detail.

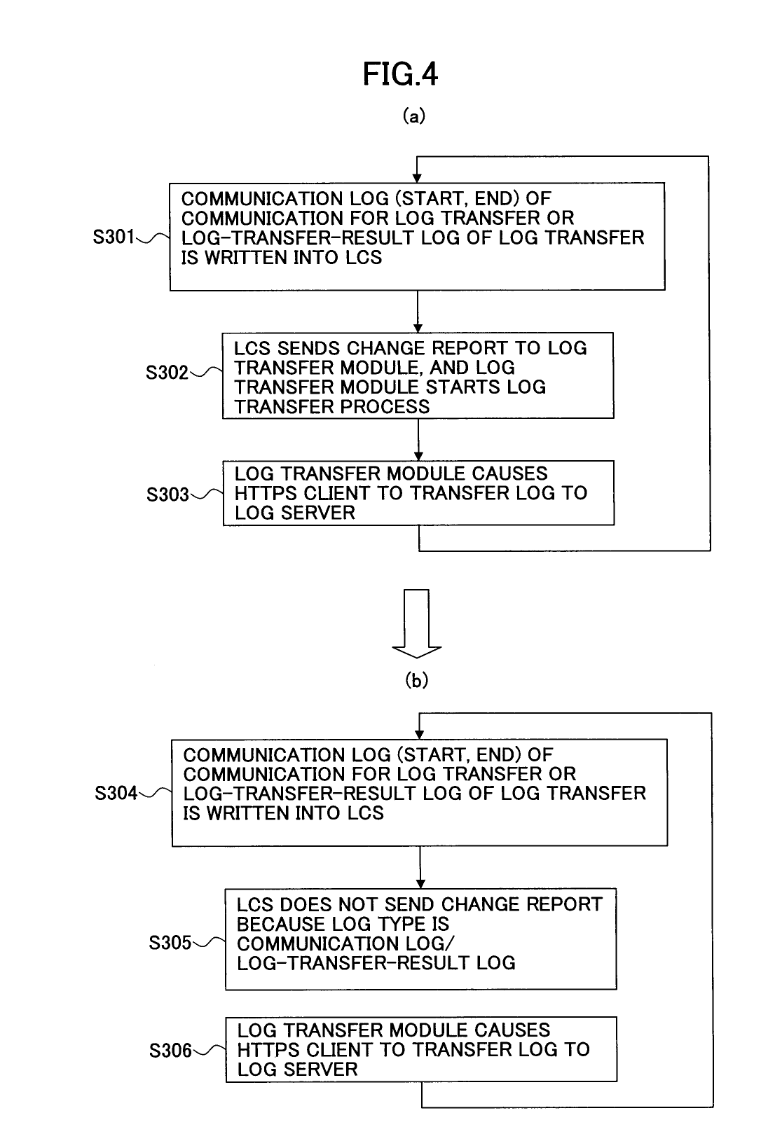

The following is a brief description of the present embodiment. FIG. 4 is a diagram used to describe an advantageous effect of the log transfer system of the present embodiment. In (a) of FIG. 4, a problem with a related-art log transfer system is illustrated. As shown in (a) of FIG. 4, in Step S301, a communication log or a log-transfer-result log is written into the LCS 205. The communication log is a log information item about a communication indicating the start or the end of a communication and is generated in response to a communication for a log transfer. The log-transfer-result log is a log information item about a log transfer result and is generated in response to a log transfer.

If the communication log or the log-transfer-result log is written, then in Step S302, the LCS 205 sends a log change report to the log transfer module 207. In response to reception of the log change report from the LCS 205, the log transfer module 207 starts a log transfer process. Then in Step S303, the log transfer module 207 causes the https client 208 to transfer the log information item to the https server of the log server 209. In response to the log transfer in Step S303, another communication log and another log-transfer-result log are generated. Therefore, the process returns from Step S303 to Step S301, resulting in entering into an endless loop. Thus, in (a) of FIG. 4, the device 1 continues to generate communication logs and log-transfer-result logs.

In (b) of FIG. 4, an advantageous effect of the log transfer system of the present embodiment is illustrated. As shown in (b) of FIG. 4, in Step S304, as in Step S301, a communication log or a log-transfer-result log is written into the LCS 205.

Then in Step S305, because the type of the written log information item is the communication log or the log-transfer-result log, the LCS 205 does not send a log change report to the log transfer module 207. Accordingly, in (b) of FIG. 4, the process does not proceed to Step S306, and therefore a log transfer process by the log transfer module 207 is not executed.

In this way, the log transfer system of the present embodiment determines the type (log type) of a log information item and, if the log type is the communication log or the log-transfer-result log, does not send a log change report to the log transfer module 207, thereby preventing the process from proceeding from Step S305 to S306 and thus preventing entering into an endless loop.

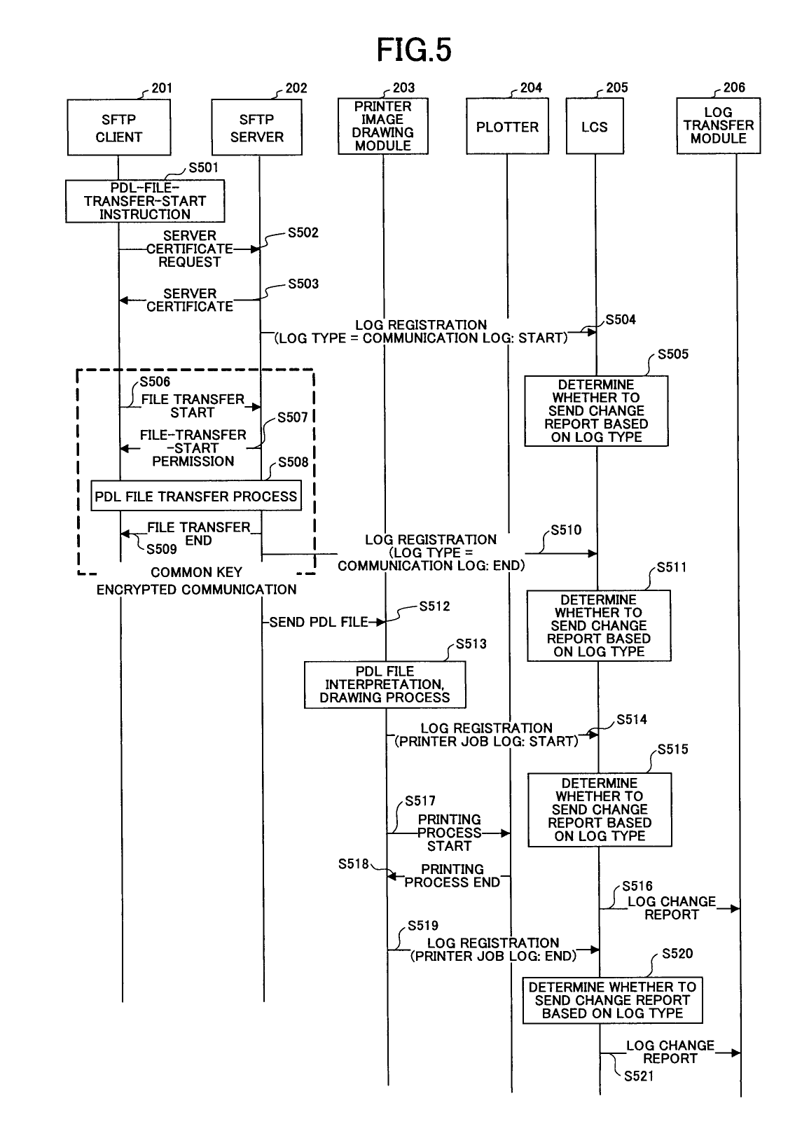

FIG. 5 is a sequence diagram showing a process of printing a PDL file transferred from the client PC 201. In Step S501, the SFTP client of the client PC 201 receives a PDL file transfer instruction. Then in Step S502, the SFTP client of the client PC 201 sends a server certificate request to the SFTP server 202 of the device 1. Then in Step S503 the SFTP client of the client PC 201 receives a server certificate from the SFTP server 202 of the device 1. The server certificate includes a common key encrypted by a secret key, and a public key.

Then in Step S504 the SFTP server 202 of the device 1 registers into the LCS 205 a communication log indicating the start of a communication. Then in Step S505 the LCS 205 determines whether to send a log change report based on the log type of the registered log. Since the log type is the communication log, the LCS 205 determines not to send a log change report.

In Steps S506-S509 the SFTP client of the client PC 201 sends a PDL file to the SFTP server 202 of the device 1. Then in Step S510 the SFTP server 202 of the device 1 registers into the LCS 205 a communication log indicating completion of the communication. Then in Step S511 the LCS 205 determines whether to send a log change report based on the log type of the registered log. Since the log type is the communication log, the LCS 205 determines not to send a log change report.

Then in Step S512 the SFTP server 202 sends the PDL file to the printer image drawing module 203. Then in Step S513 the printer image drawing module 203 interprets the PDL file and performs a drawing process.

Then in Step S514 the SFTP server 202 of the device 1 registers into the LCS 205 a printer job log indicating the start of a printer job. Then in Step S515 the LCS 205 determines whether to send a log change report based on the log type of the registered log. Since the log type of the registered log is the printer job log, the LCS 205 determines to send a log change report. Then in Step S516 the LCS 205 sends a log change report to the log transfer module 207.

Then in Step S517 the printer image drawing module 203 requests the plotter 204 to start a printing process. Then in Step S518 the printer image drawing module 203 receives a response indicating completion of the printing process from the plotter 204.

Then in Step S519 the SFTP server 202 of the device 1 registers into the LCS 205 a printer job log indicating completion of the printer job. Then in Step S520 the LCS 205 determines whether to send a log change report based on the log type of the registered log. Since the log type is the printer job log, the LCS 205 determines to send a log change report. In Step S521 the LCS 205 sends a log change report to the log transfer module 207.

In the processing shown in the sequence diagram of FIG. 5, if the log type of a registered log information item is one that causes endless generation of log change reports, the LCS 205 determines not to send a log change report, thereby preventing entering into an endless loop.

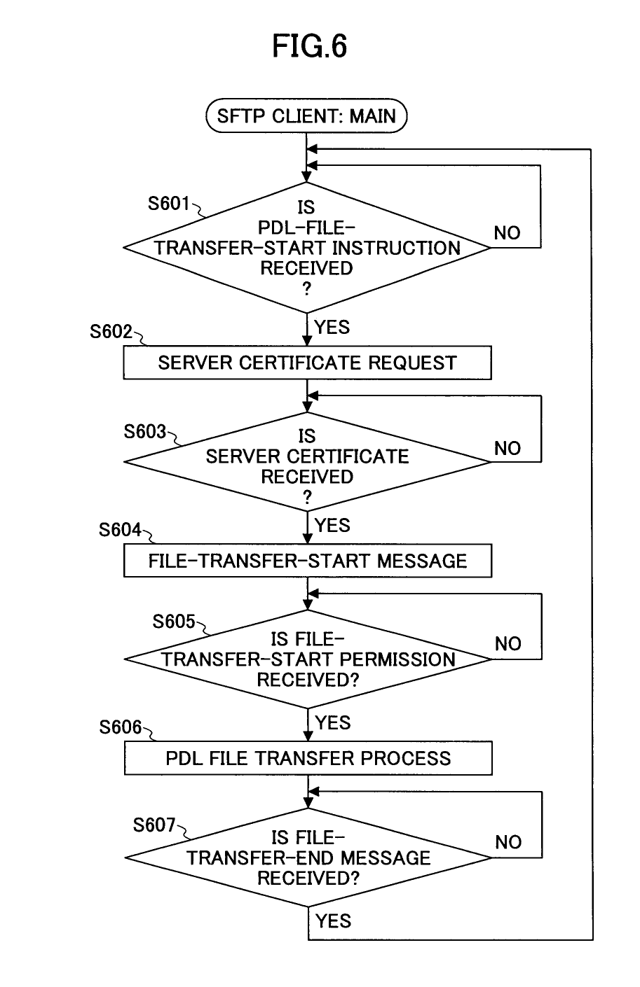

The following describes the processing performed by the SFTP client of the client PC 201 of FIG. 5. FIG. 6 is a flowchart showing an example of the processing by the SFTP client. In Step S601 the SFTP client waits for a PDL file-transfer-start instruction.

If the SFTP client receives a PDL file-transfer-start instruction, then in Step S602 the SFTP client sends a server certificate request to the SFTP server 202 of the device 1. Then in Step S603 the SFTP client waits for a server certificate.

If the SFTP client receives a server certificate, then in Step S604 the SFTP client sends a file-transfer-start message to the SFTP server 202 of the device 1. Then in Step S605 the SFTP client waits for a file-transfer-start permission from the SFTP server 202 of the device 1. If the SFTP client receives a file-transfer-start permission, then in Step S606 the SFTP client performs a PDL file transfer process for transferring a PDL file to the SFTP server 202 of the device 1.

Then in Step S607 the SFTP client waits for a file-transfer-end message from the SFTP server 202 of the device 1. If the SFTP client receives a file-transfer-end message, the process returns to Step S601.

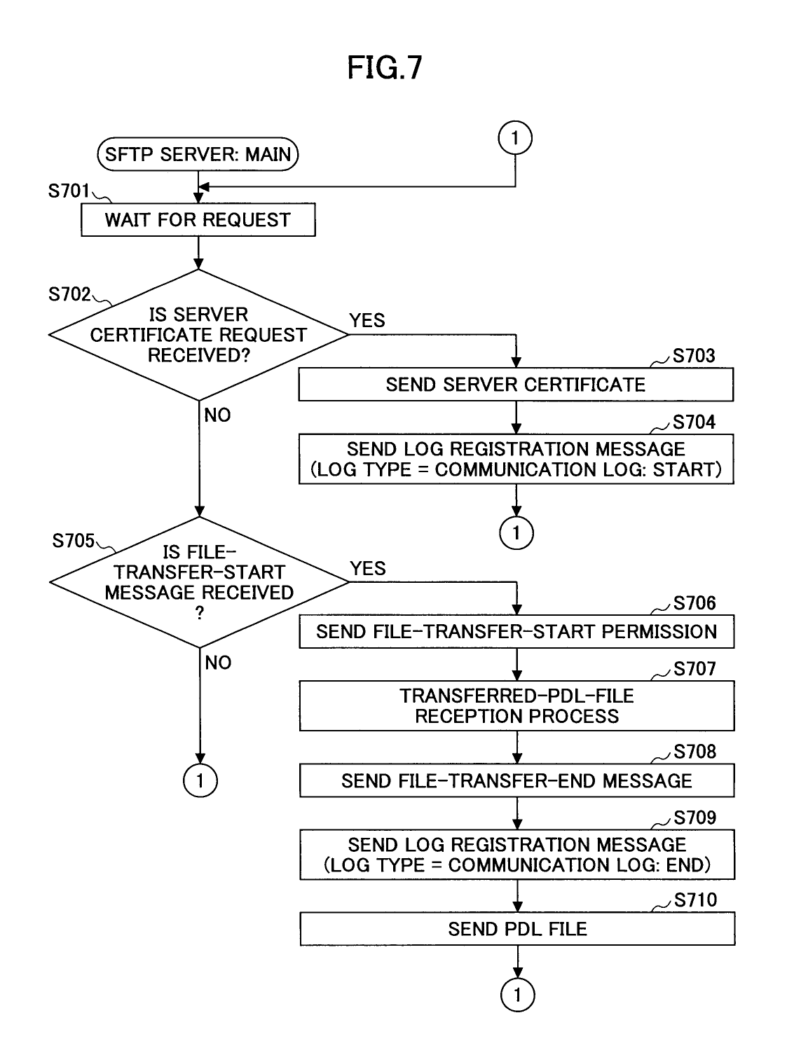

The following describes the processing performed by the SFTP server 202 of the device 1 of FIG. 5. FIG. 7 is a flowchart showing an example of the processing by the SFTP server 202. In Step S701 the SFTP server 202 waits for a request from the SFTP client of the client PC 201. If the SFTP server 202 receives a request from the SFTP client of the client PC 201, then in Step S702 the SFTP server 202 determines whether the received request contains a server certification request.

If the received request contains a server certification request, then in Step S703 the SFTP server 202 sends a server certificate to the SFTP client. Then in Step S704 the SFTP server 202 sends to the LCS 205 a log registration message for registering a communication log that indicates the start of a communication. Then the process returns to Step S701.

If in Step S702 the received request does not contain a server certificate request, then in Step S705 the SFTP server 202 determines whether the received request contains a file-transfer-start message.

If in Step S705 the received request contains a file-transfer-start message, then in Step S706 the SFTP server 202 sends a file-transfer-start permission to the SFTP client. Then in Step S707 the SFTP server 202 performs a transferred-PDL-file reception process for receiving a PDL file transferred from the SFTP client.

Then in Step S708 the SFTP server 202 sends a file-transfer-end message to the SFTP client. Then in Step S709 the SFTP server 202 sends to the LCS 205 a log registration message for registering a communication log that indicates completion of the communication. Then in Step S710 the SFTP server 202 sends the PDL file to the printer image drawing module 203. Then the process returns to Step S701. If in Step S705 the received request does not contain a file-transfer-start message, the process returns to Step S701.

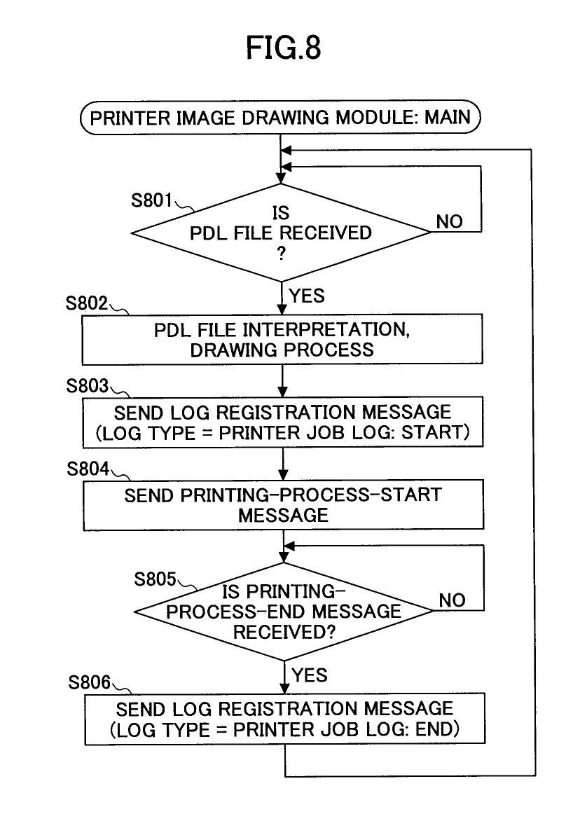

The following describes the processing by the printer image drawing module 203 of the device 1 of FIG. 5. FIG. 8 is a flowchart showing an example of the processing by the printer image drawing module 203. In Step S801 the printer image drawing module 203 waits for a PDL file from the SFTP server 202.

If a PDL file is received, then in Step S802 the printer image drawing module 203 interprets the PDL file and performs a drawing process. Then in Step S803 the printer image drawing module 203 sends to the LCS 205 a log registration message for registering a printer job log that indicates the start of a printer job.

Then in Step S804 the printer image drawing module 203 sends a printing-process-start message to the plotter 204. Then in Step S805 the printer image drawing module 203 determines whether a printing-process-end message is received from the plotter 204. The processing in Step S805 is repeated until the printer image drawing module 203 receives a printing-process-end message.

If a printing-process-end message is received, then in Step S806 the printer image drawing module 203 sends to the LCS 205 a log registration message for registering a printer job log that indicates completion of the printer job. Then the process returns to Step S801.

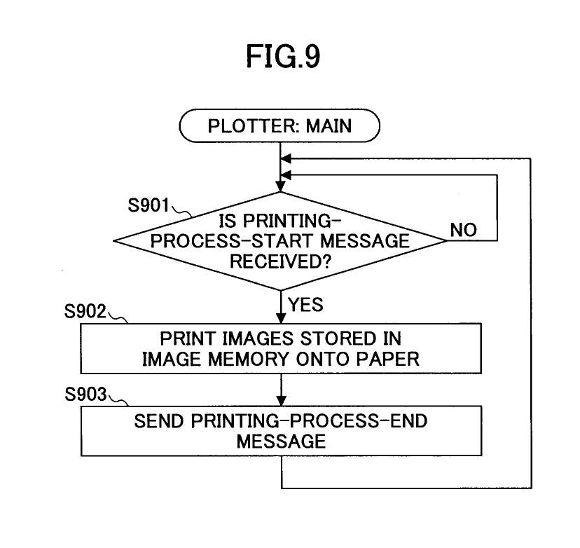

The following describes processing by the plotter 204 of the device 1 of FIG. 5. FIG. 9 is a flowchart showing an example of the processing by the plotter 204. In Step S901 the plotter 204 waits for a printing-process-start message from the printer image drawing module 203. If a printing-process-start message is received, then in Step S902 the plotter 204 prints images stored in an image memory onto paper. Then in Step S903 the plotter 204 sends a printing-process-end message to the printer image drawing module 203. Then the process returns to Step S901.

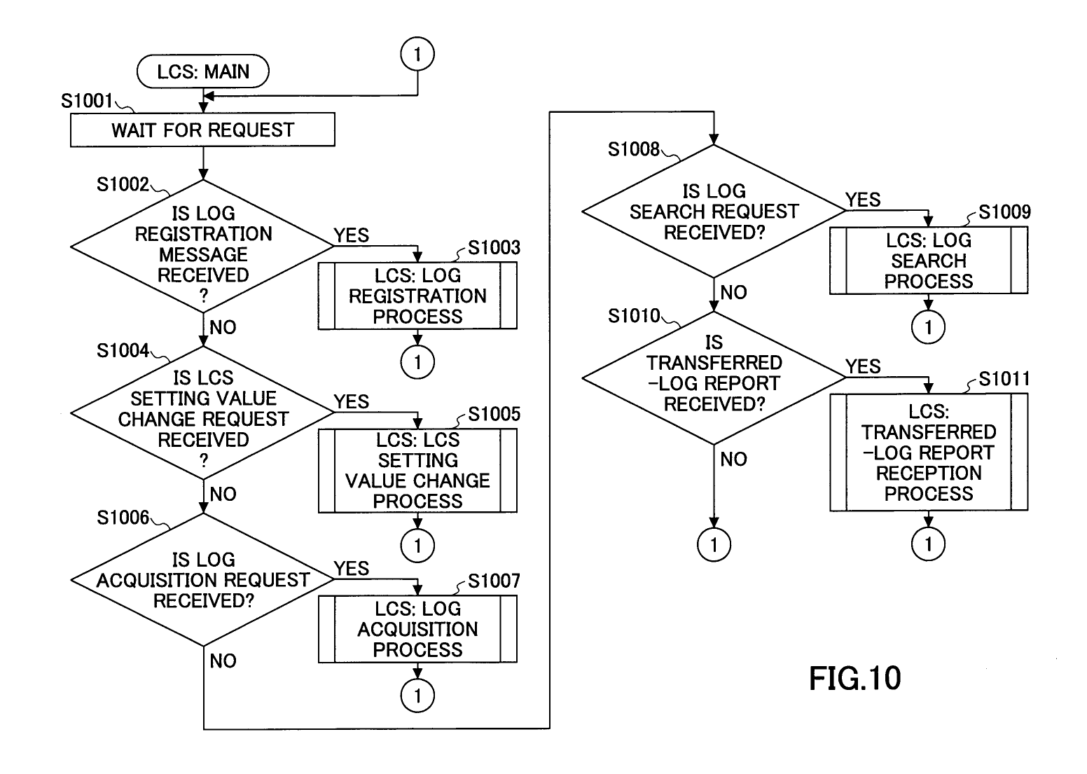

The following describes processing by the LCS 205 of the device 1 of FIG. 5. FIG. 10 is a flowchart showing an example of the processing by the LCS 205. In Step S1001, the LCS 205 waits for a request.

If a request is received, then in Step S1002 the LCS 205 determines whether the received request contains a log registration message. If the received request contains a log registration message, then in Step S1003 the LCS 205 performs a log registration process described below.

If in Step S1002 the received request does not contain a log registration request, then in Step S1004 the LCS 205 determines whether the received request contains an LCS setting value change request. If the received request contains an LCS setting value change request, then in Step S1005 the LCS 205 performs an LCS setting value change process described below.

If in Step S1004 the received request does not contain an LCS setting value change request, then in Step S1006 the LCS 205 determines whether the received request contains a log acquisition request. If the received request contains a log acquisition request, then in Step S1007 the LCS 205 performs a log acquisition process described below.

If in Step S1006 the received request does not contain a log acquisition request, then in Step S1008 the LCS 205 determines whether the received request contains a log search request. If the received request contains a log search request, then in Step S1009 the LCS 205 performs a log search process described below.

If in Step S1008 the received request does not contain a log search request, then in Step S1010 the LCS 205 determines whether the received request contains a transferred-log report. If the received request contains a transferred-log report, then in Step S1011 the LCS 205 performs a transferred-log report reception process as described below. If the received request does not contain a transferred-log report, the process returns to Step S1001.

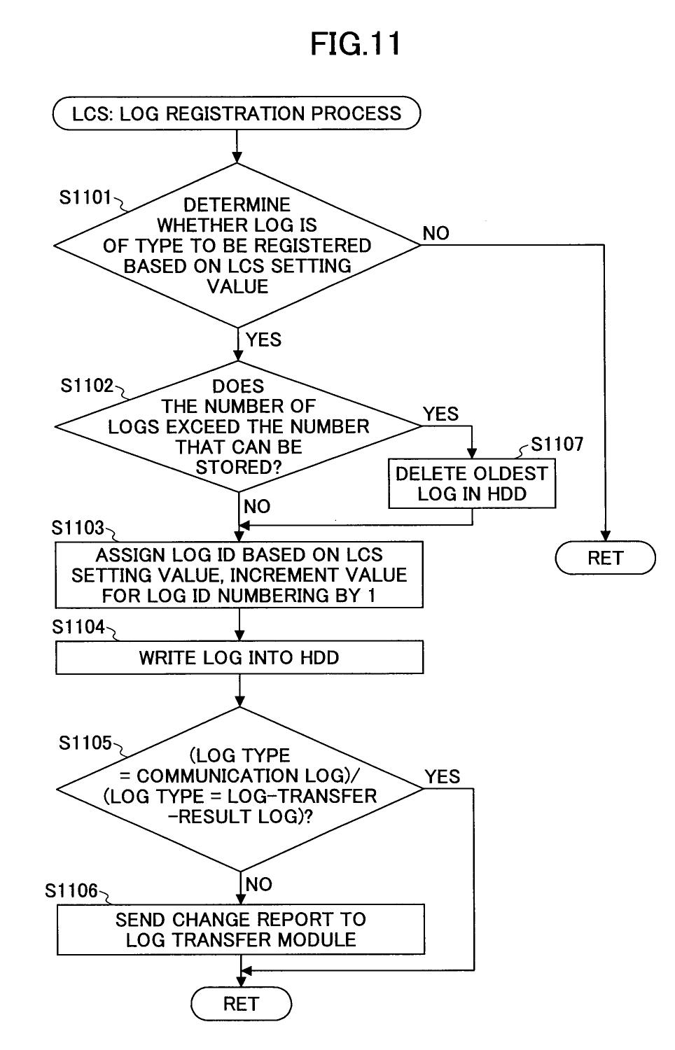

FIG. 11 is a flowchart showing an example of a log registration process. In Step S1101, the LCS 205 determines whether a log information item specified in a log registration message is of a log type to be registered based on the LCS setting values 214. If the log information item is not of the log type to be registered, the LCS 205 ends the log registration process.

If in Step S1101 the log information item is of the type to be registered, then in Step S1102 the LCS 205 determines whether, if the log information item is to be registered, the number of log information items in the HDD 15 exceeds the number of log information items storable in the HDD 15. If the number of log information items exceeds the number that can be stored, then in Step S1107 the oldest log information item in the HDD 15 is deleted. Then the process proceeds to Step S1103. If in Step S1102 the number of log information items does not exceed the number that can be stored, then the process proceeds to Step S1103.

In Step S1103 the LCS 205 assigns a log ID to the log information item based on the LCS setting value 214 for log ID numbering. The LCS 205 then increments the value for log ID numbering by 1. Then in Step S1104 the LCS 205 writes the log information item into the HDD 15.

Then in Step S1105 the LCS 205 determines whether the log type of the information item is the communication log or the log-transfer-result log. If the log type of the log information item is not the communication log or the log-transfer-result log, then in Step S1106 the LCS 205 sends a log change report to the log transfer module 207. Thus, the log registration process ends. If the log type of the log information item is the communication log or the log-transfer-result log, the log registration process ends without sending a log change report to the log transfer module 207.

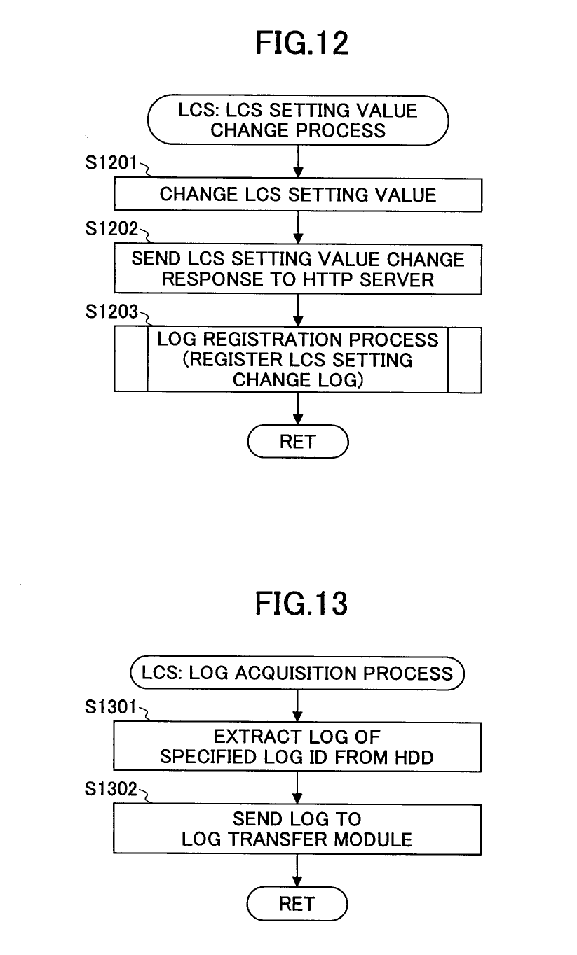

FIG. 12 is a flowchart showing an example of an LCS setting value change process. In Step S1201, the LCS 205 changes the LCS setting value 214 according to an LCS setting value change request. Then in Step S1202, the LCS 205 sends an LCS setting value change response to the https server 210. Then in Step S1203, the LCS 205 performs a log registration process as shown in FIG. 11 to register an LCS setting change log as a log information item. Thus, the LCS setting value change process ends.

FIG. 13 is a flowchart showing an example of a log acquisition process. In Step S1301 the LCS 205 extracts from the HDD 15a log information item of a log ID specified in a log acquisition request. Then in Step S1302 the LCS 205 sends the extracted log information item to the log transfer module 207. Thus, the log acquisition process ends.

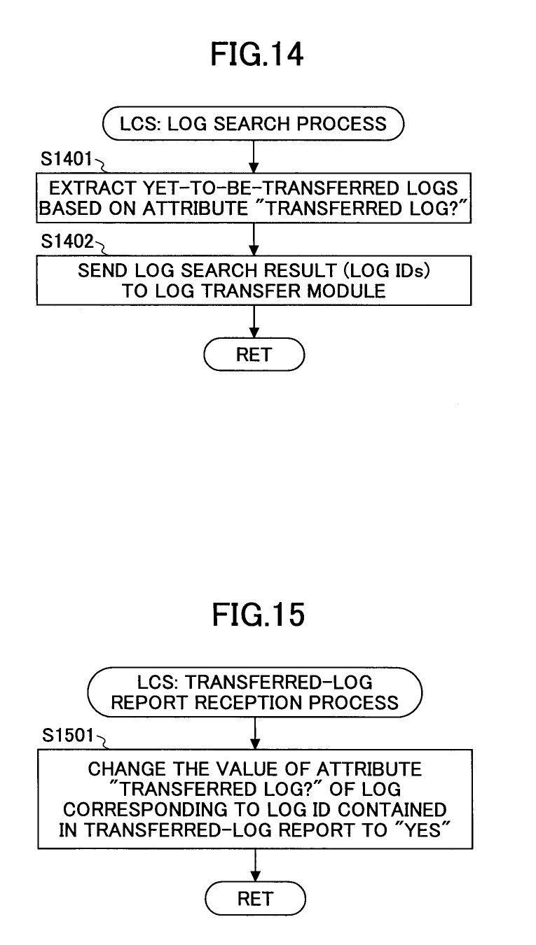

FIG. 14 is a flowchart showing an example of a log search process. In Step S1401 the LCS 205 refers to an attribute “transferred log?” of each log information item stored in the HDD 15 or the RAM 16 and extracts log information items that are not yet transferred. Then in Step S1402 the LCS 205 sends the log search result (the log IDs of the yet-to-be-transferred logs) to the log transfer module 207. Thus, the log search process ends.

FIG. 15 is a flowchart showing an example of a transferred-log report reception process.

### In Step S1501 the LCS 205 changes the value of an attribute “transferred log?” of a log information item corresponding to the log ID contained in a transferred-log report to “YES”. Thus, the transferred-log report reception process ends.

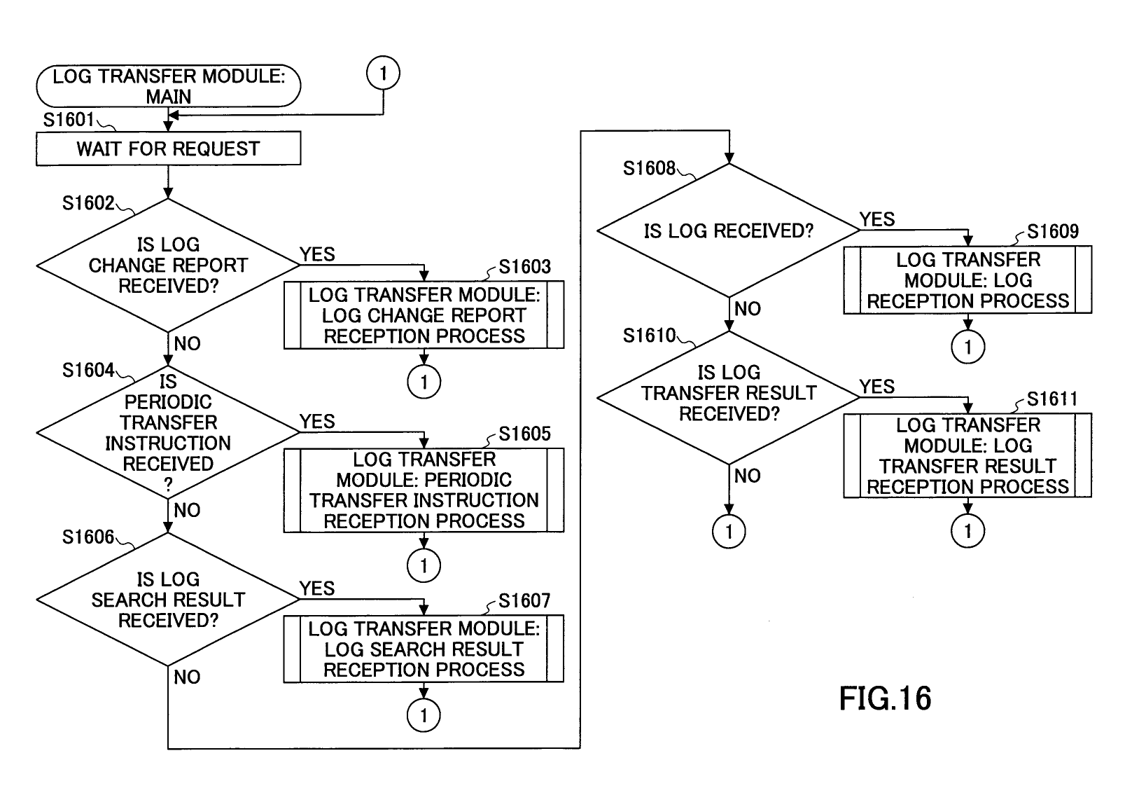

The following describes the processing by the log transfer module 207 of the device 1 of FIG. 5. FIG. 16 is a flowchart showing an example of the processing by the log transfer module 207. In Step S1601 the log transfer module 207 waits for a request.

If a request is received, then in Step S1602 the log transfer module 207 determines whether the received request contains a log change report. If the received request contains a log change report, then in Step S1603 the log transfer module 207 performs a log change report reception process described below.

If in Step S1602 the received request does not contain a log change request, then in Step S1604 the log transfer module 207 determines whether the received request contains a periodic transfer instruction. If the received request contains a periodic transfer instruction, then in Step S1605 the log transfer module 207 performs a periodic transfer instruction reception process described below.

If in Step S1604 the received request does not contain a periodic transfer instruction, then in Step S1606 the log transfer module 207 determines whether the received request contains a log search result. If the received request contains a log search result, then in Step S1607 the log transfer module 207 performs a log search result reception process described below.

If in Step S1606 the received request does not contain a log search result, then in Step S1608 the log transfer module 207 determines whether the received request contains a log. If the received request contains a log, then in Step S1609 the log transfer module 207 performs a log reception process described below.

If in Step S1608 the received request does not contain a log, then in Step S1610 the log transfer module 207 determines whether the received request contains a log transfer result. If the received request contains a log transfer result, then in Step S1611 the log transfer module 207 performs a log transfer result reception process described below. If the received request does not contain a log transfer result, the process returns to Step S1601.

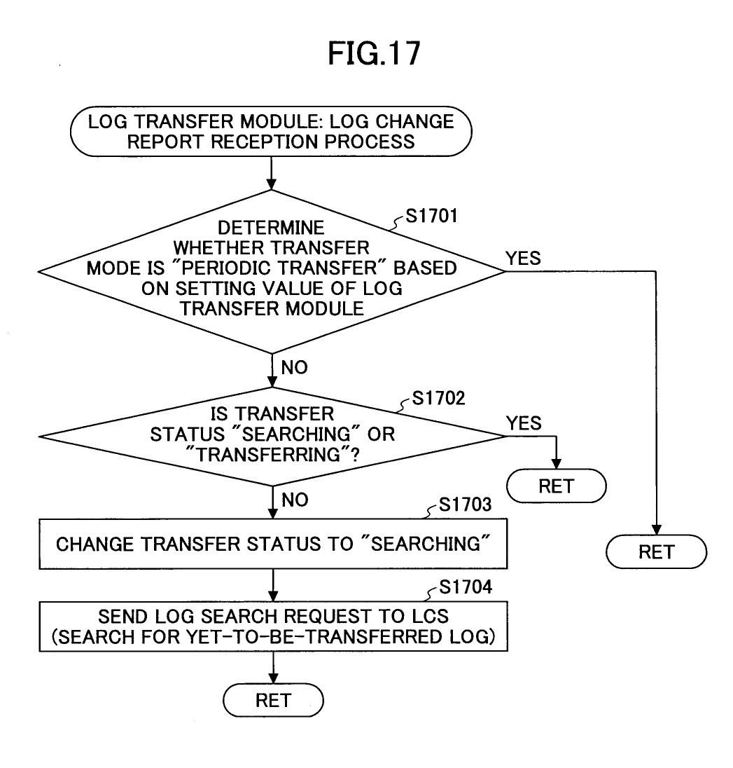

FIG. 17 is a flowchart showing an example of a log change report reception process. In Step S1701 the log transfer module 207 determines whether the transfer mode is “periodic transfer” based on the setting value of the log transfer module 207. If the transfer mode is “periodic transfer”, the log transfer module 207 ends the change report reception process.

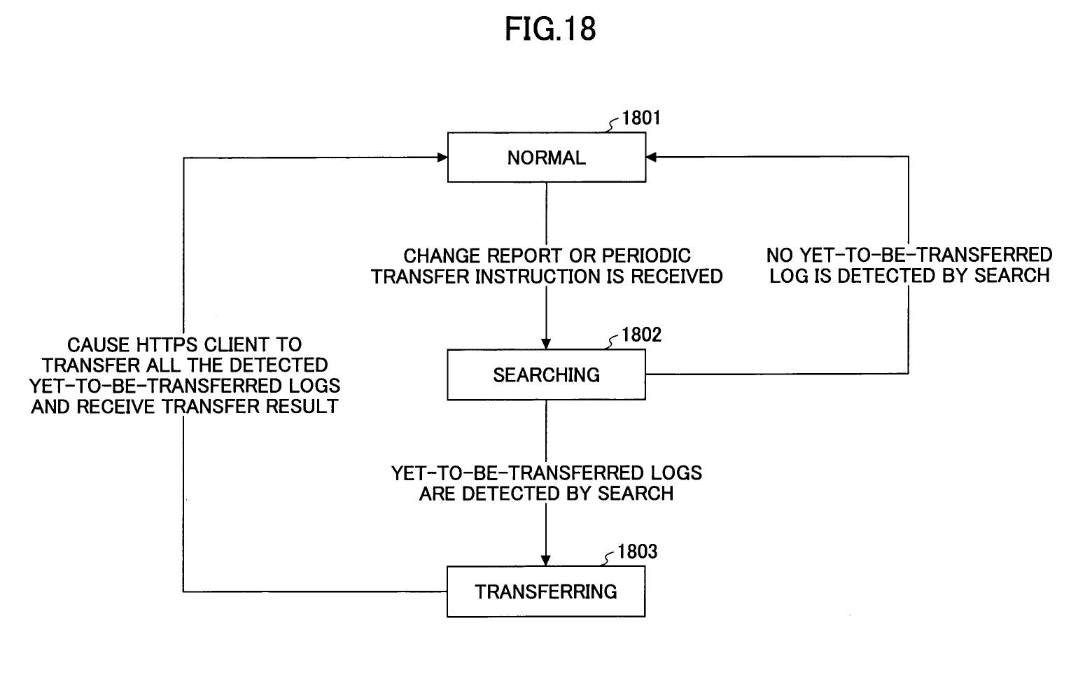

If in Step S1701 the transfer mode is not “periodic transfer”, then in Step S1702 the log transfer module 207 determines whether the transfer status is “searching” 1802 or “transferring” 1803. FIG. 18 is a chart showing a transition of the transfer status of the log transfer module 207. If the transfer status is “searching” 1802 or “transferring” 1803, the log transfer module 207 ends the log change report reception process. If the transfer status is not “searching” 1802 or “transferring” 1803, the process proceeds to Step S1703.

In Step S1703 the log transfer module 207 changes the transfer status to “searching” 1802. Then in Step S1704 the log transfer module 207 sends a log search request to the LCS 205. Thus, the log change report reception process ends.

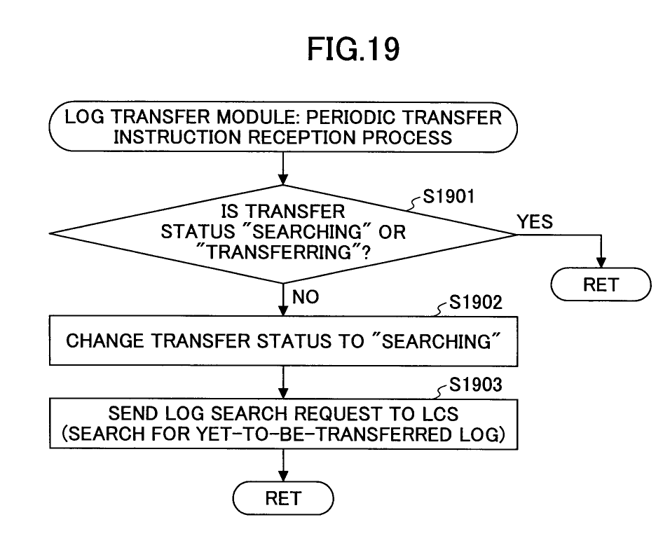

FIG. 19 is a flowchart showing an example of a periodic transfer instruction receiving process. In Step S1901 the log transfer module 207 determines whether the transfer status is “searching” 1802 or “transferring” 1803. If the transfer status is “searching” 1802 or “transferring” 1803, the log transfer module 207 ends the log change report reception process. If the transfer status is not “searching” 1802 or “transferring” 1803, the process proceeds to Step S1902.

In Step S1902 the log transfer module 207 changes the transfer status to “searching” 1802. Then in Step S1903 the log transfer module 207 sends a log search request to the LCS 205. Thus, the periodic transfer instruction reception process ends.

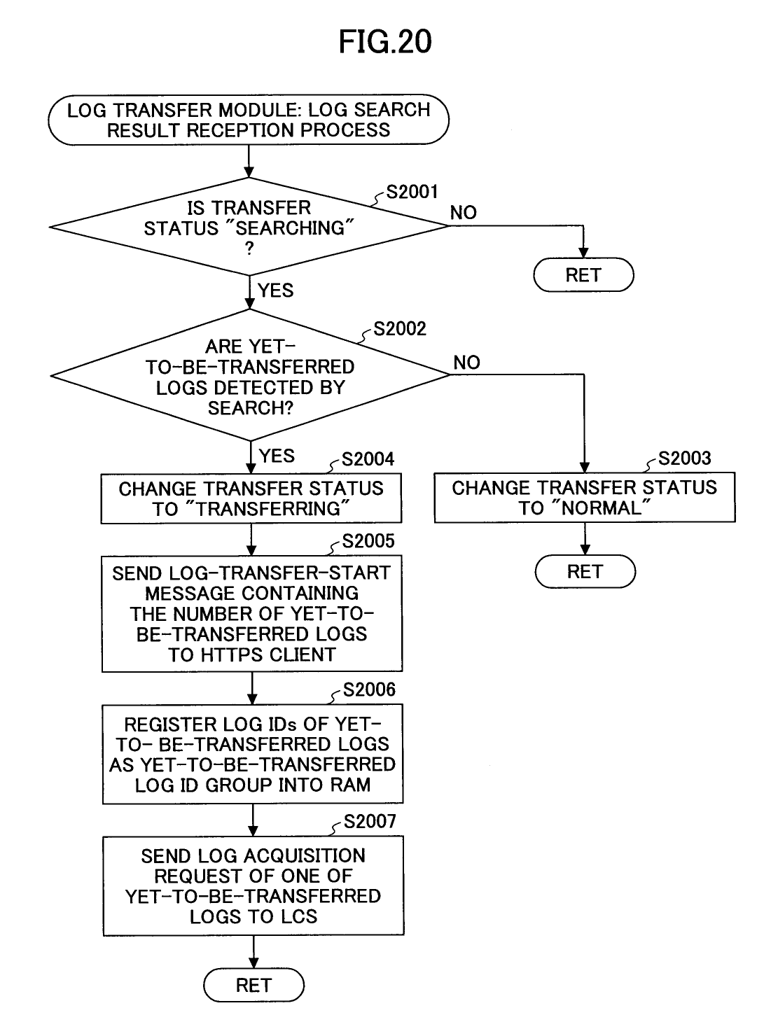

FIG. 20 is a flowchart showing an example of a log search result reception process. In Step S2001 the log transfer module 207 determines whether the transfer status is “searching” 1802. If the transfer status is not “searching” 1802, the log transfer module 207 ends the log search result reception process.

If in Step S2001 the transfer status is “searching” 1802, then in Step S2002 the log transfer module 207 determines whether a yet-to-be-transferred log is detected as a result of the search. If no yet-to-be-transferred log is detected, then in Step S2003 the log transfer module 207 changes the transfer status to “normal” 1801. Thus, the log search result reception process ends. If yet-to-be-transferred logs are detected, then in Step S2004 the log transfer module 207 changes the transfer mode to “transferring” 1803.

Then in Step S2005, the log transfer module 207 transfers a log-transfer-start message containing the number of yet-to-be-transferred logs to the https client 208. Then in Step S2006 the log transfer module 207 registers log IDs of the yet-to-be-transferred logs into the RAM 16 as a yet-to-be-transferred log ID group.

Then in Step S2007 the log transfer module 207 sends to the LCS 205 a log acquisition request for acquiring an arbitrary one of the yet-to-be-transferred logs. Thus, the log search result reception process ends.

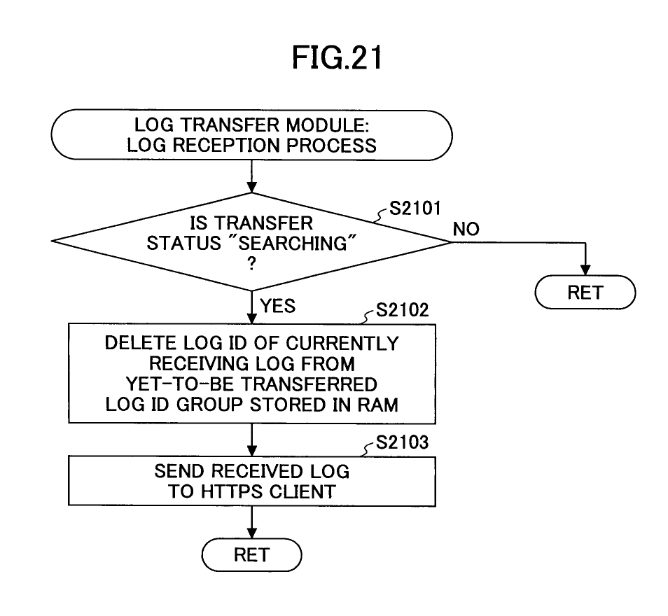

FIG. 21 is a flowchart showing an example of a log reception process. In Step S2101 the log transfer module 207 determines whether the transfer status is “transferring” 1803. If the transfer status is not “transferring” 1803, the log transfer module 207 ends the log reception process. If the transfer status is “transferring” 1803, then in Step S2102 the log transfer module 207 deletes the log ID of the currently receiving log information item from the yet-to-be-transferred log ID group stored in the RAM 16. Then in Step S2103 the log transfer module 207 transfers the received log information item to the https client 208. Thus, the log reception process ends.

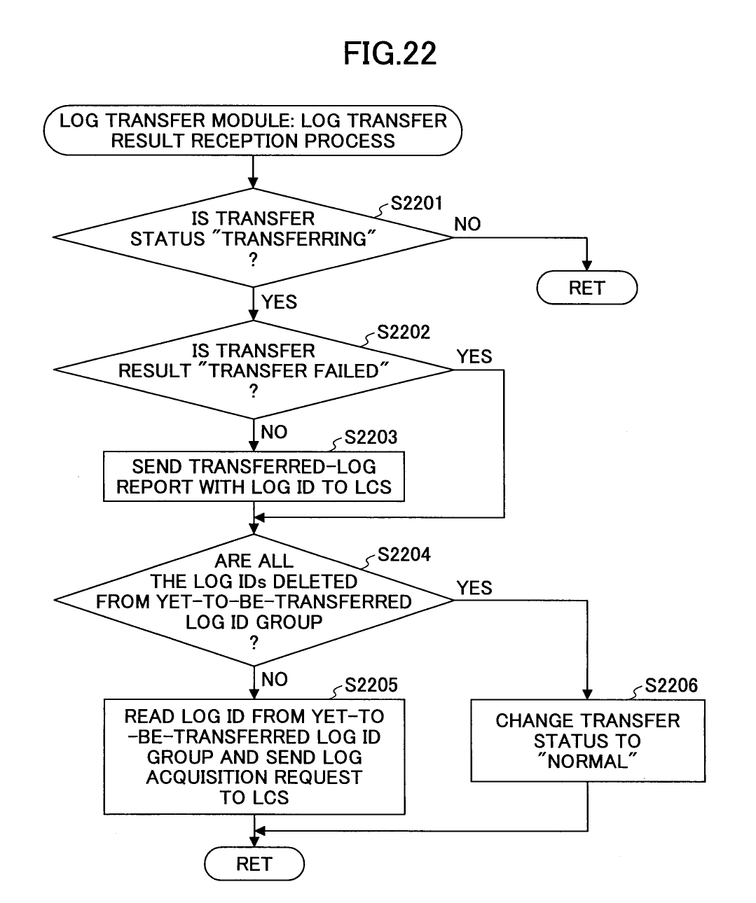

FIG. 22 is a flowchart showing an example of a log transfer result reception process. In Step S2201 the log transfer module 207 determines whether the transfer status is “transferring” 1803. If the transfer status is not “transferring” 1803, the log transfer module 207 ends the log transfer result reception process.

If in Step S2201 the transfer status is “transferring” 1803, then in Step S2202 the log transfer module 207 determines whether the transfer result is “transfer failed”.

If in Step S2202 the transfer result is not “transfer failed”, then in Step S2203 the log transfer module 207 sends a transferred-log report containing the log ID of the transferred log information item to the LCS 205. Then the process proceeds to Step S2204. If in Step S2202 the transfer result is “transfer failed”, then the process proceeds to Step S2204.

In Step S2204 the log transfer module 207 determines whether all the log IDs are deleted from the yet-to-be-transferred log ID group stored in the RAM 16. If all the log IDs are deleted from the yet-to-be-transferred log ID group, then in Step S2206 the log transfer module 207 changes the transfer status to “normal” 1801. Thus, the log transfer result reception process ends. If the yet-to-be-transferred log ID group still contains log IDs, then in Step S2205 the log transfer module reads an arbitrary one of the log IDs from the yet-to-be-transferred log ID and sends to the LCS 205 a log acquisition request for acquiring a log information item corresponding to the read log ID. Thus, the log transfer result reception process ends.

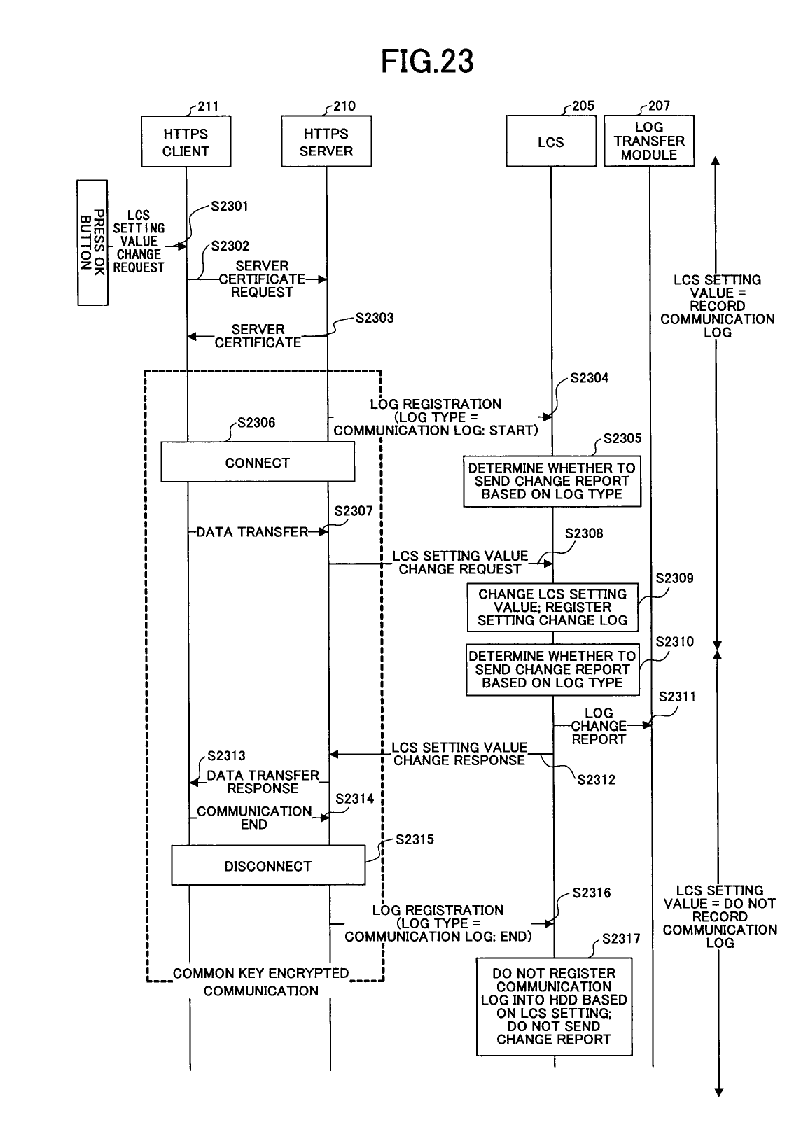

FIG. 23 is a sequence diagram showing a process of changing an LCS setting value 214 using the client PC 211. In Step S2301 a user enters an LCS setting value 214 and presses an OK button on, e.g., a Web screen to issue an LCS setting value change request.

Then in Step S2302 in response to the LCS setting value change request, the https client of the client PC 211 sends a server certificate request to the https server 210 of the device 1. Then in Step S2303 the https client of the client PC 211 receives a server certificate from the https server 210 of the device 1.

Then in Step S2304 the https server 210 of the device 1 registers a communication log indicating the start of a communication into the LCS 205. Then in Step S2305 the LCS 205 determines whether to send a log change report based on the log type of the registered log. Since the log type is the communication log, the LCS 205 determines not to send a log change report. Further, since an LCS value indicating “record a communication log” is selected, the LCS 205 records a communication log into the HDD 15.

Then in Step S2306 the https client of the client PC 211 is connected to the https server 210 of the device 1 for enabling data transfer. Then in Step S2307 the https client of the client PC 211 sends data for changing the LCS setting value 214 to the https server 210 of the device 1.

Then in Step S2308 the https server 210 sends an LCS setting value change request to LCS 205 based on the data received from the https client of the client PC 211.

Then in Step S2309 the LCS 205 changes the LCS setting value 214 to “do not record a communication log” based on the LCS setting value change request, and records a setting change log into the HDD 15. Then in Step S2310 the LCS 205 determines whether to send a log change report based on the log type of the recorded log.

Since the log type is the setting change log, the LCS 205 determines to send a log change report. Then in Step S2311 the LCS 205 sends a log change report to the log transfer module 207.

Then in Step S2312 the LCS 205 sends an LCS setting value change response to the https server 210. Then in Step S2313 the https server 210 sends a data transfer response to the https client of the client PC 211. Then in Step S2314 the https client of the client PC 211 sends a communication-end message to the https server 210 of the device 1. Then in Step S2315 the https client of the client PC 211 is disconnected from the https server 210 of the device 1.

Then in Step S2316 the https server 210 of the device 1 registers a communication log indicating the completion of the communication into the LCS 205. Then in Step S2317 the LCS 205 determines whether to send a log change report based on the log type of the registered log. Since the log type is the communication log, the LCS 205 determines not to send a log change report. Further, since the LCS setting value 214 indicating “do not record a communication log” is selected, the LCS 205 does not record the communication log into the HDD 15.

In the processing shown in the sequence diagram of FIG. 23, if the log type of a registered log information item is one that causes endless generation of log change reports, the LCS 205 determines not to send a log change report, thereby preventing entering into an endless loop. Further, the log information item to be recorded into the HDD 15 is specified by the client PC 211. That is, a user can change the LCS setting value 214 using the client PC 211.

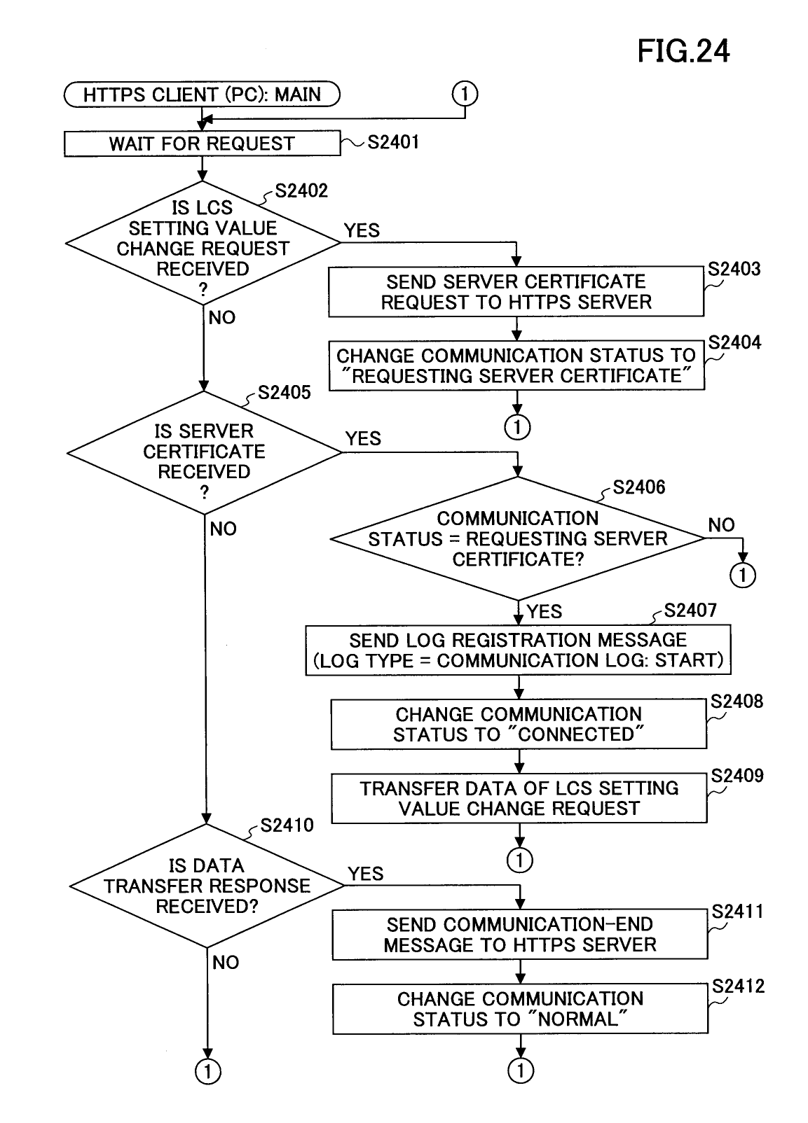

The following describes processing performed by the https client of the client PC 211 of FIG. 23. FIG. 24 is a flowchart showing an example of the processing by the https client. In Step S2401 the https client of the client PC 211 waits for a request.

If a request is received, then in Step S2402 the https client determines whether the received request contains an LCS setting value change request. If the received request contains an LCS setting value change request, then in Step S2403 the https client sends a server certificate request to the https server 210 of the device 1.

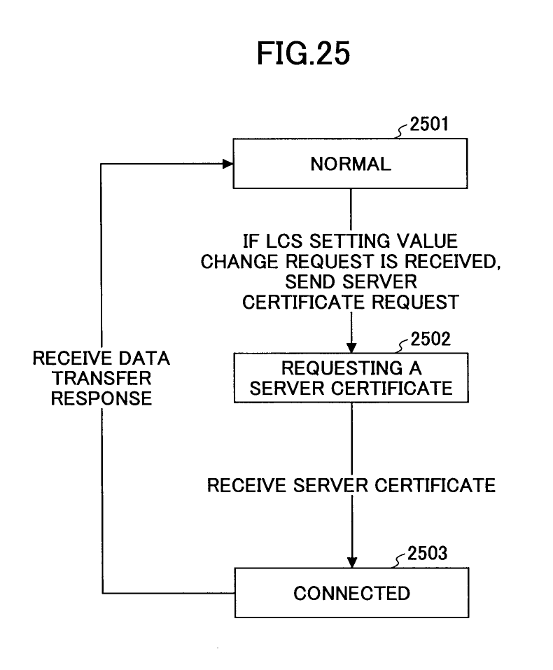

Then in Step S2404 the https client changes the communication status from “normal” 2501 to “requesting a server certificate” 2502. Then the process returns to Step S2401. FIG. 25 is a chart showing a transition of the communication status of the https client.

If in Step S2402 the received request does not contain an LCS setting value change request, then in Step S2405 the https client determines whether the received request contains a server certificate. If the received request contains a server certificate, then in Step S2406 the https client determines whether the communication status is “requesting a server certificate” 2502.

If in Step S2406 the communication status is not “requesting a server certificate” 2502, then the process returns to Step S2401. If the communication status is “requesting a server certificate” 2502, then in Step S2407 the https client sends to the https server 210 a log registration message for registering a communication log that indicates the start of a communication.

Then in Step S2408 the https client changes the communication status from “requesting a server certificate” 2502 to “connected” 2503. Then in Step S2409 the https client transfers data of the LCS setting value change request to the https server 210. Then the process returns to Step S2401.

If in Step S2405 the received request does not contain a server certificate, then in Step S2410 the https client determines whether the received request contains a data transfer response. If the received request contains a server certificate, then in Step S2411 the https client sends to a communication-end message to the https server 210.

Then in Step S2412 the https client changes the communication status from “connected” 2503 to “normal” 2501. Then the process returns to Step S2401. If in Step S2410 the received request does not contain a data transfer response, the process returns to Step S2401.

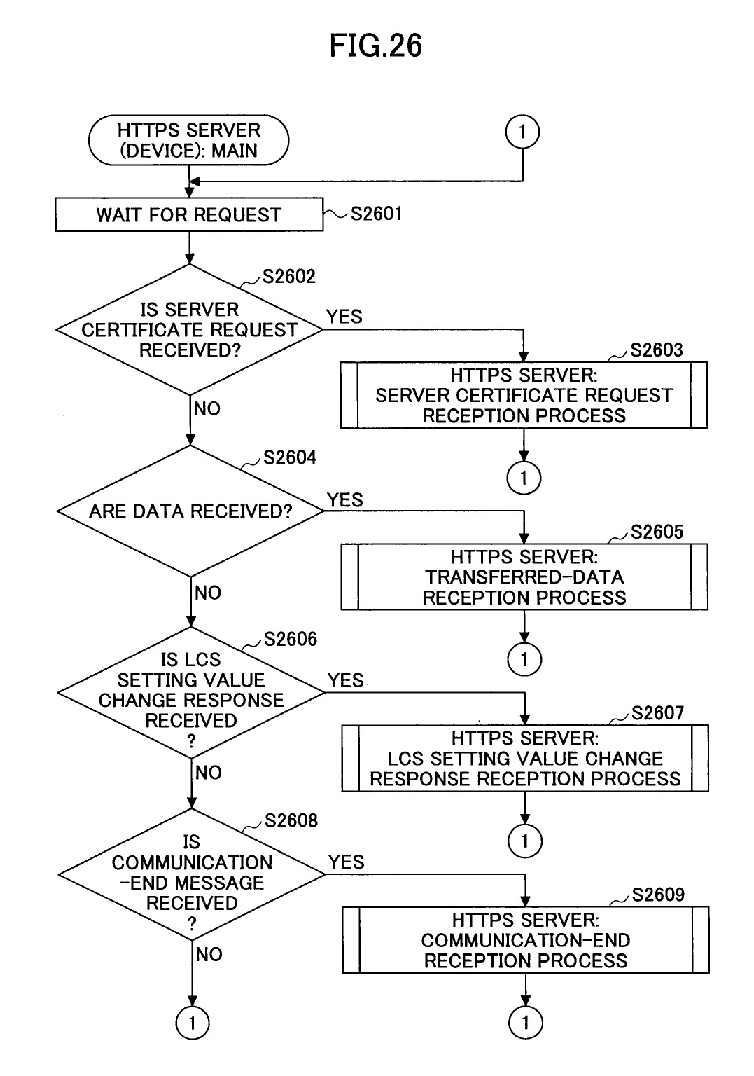

The following describes processing performed by the https server 210 of the device 1 of FIG. 23. FIG. 26 is a flowchart showing an example of the processing by the https server 210 of the device 1. In Step S2601 the https server 210 waits for a request.

If a request is received, then in Step S2602 the https server 210 determines whether the received request contains a server certificate request. If the received request contains a server certificate request, then in Step S2603 the https server 210 performs a server certificate request reception process described below.

If the received request does not contain a server certificate request, then in Step S2604 the https server 210 determines whether the received request contains data of an LCS setting value change request. If the received request contains the data, then in Step S2605 the https server 210 performs a transferred-data reception process described below.

If in Step S2604 the received request does not contain data of an LCS setting value change request, then in Step S2606 the https server 210 determines whether the received request contains an LCS setting value change response. If the received request contains an LCS setting value change response, then in Step S2607 the https server 210 performs an LCS setting value change response reception process described below.

If in Step S2606 the received request does not contain an LCS setting value change response, then in Step S2608 the https server 210 determines whether the received request contains a communication-end message. If the received request contains a communication-end message, then in Step S2609 the https server 210 performs a communication-end reception process described below. If the received request does not contain a communication-end message, the process returns to Step S2601.

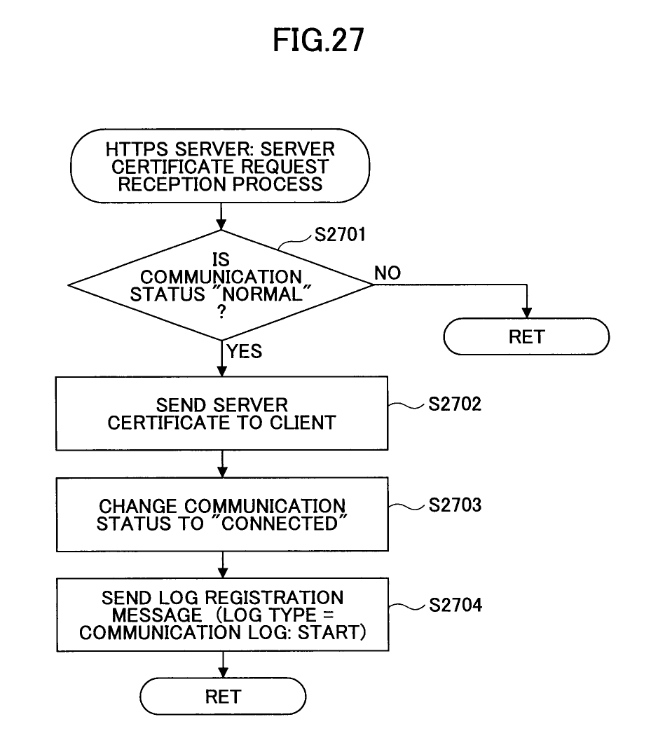

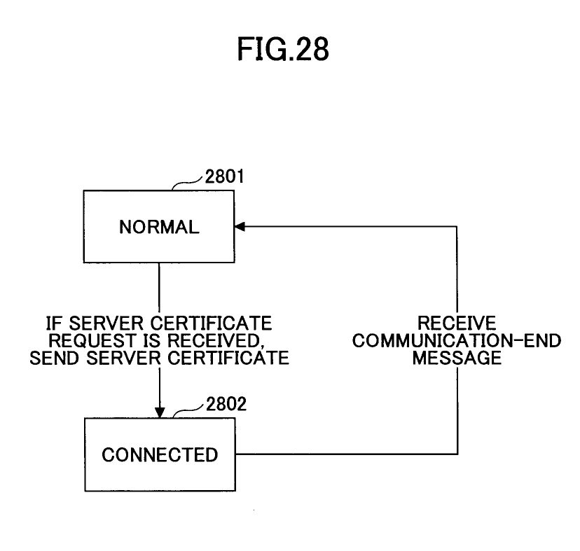

FIG. 27 is a flowchart showing an example of a server certificate request reception process. In Step S2701 the https server 210 determines whether the communication status is “normal” 2801. FIG. 28 is a chart showing a transition of the communication status of the https server 210.

If the communication status is not “normal” 2801, the https server 210 ends the server certificate request reception process. If the communication status is “normal” 2801, then in Step S2702 the https server 210 sends a server certificate to the https client of the client PC 211.

Then in Step S2703 the https server 210 changes the communication status to “connected” 2802. Then in Step S2704 the https server 210 sends to the LCS 205 a log registration message for registering a communication log that indicates the start of a communication. Thus, the server certificate request reception process ends.

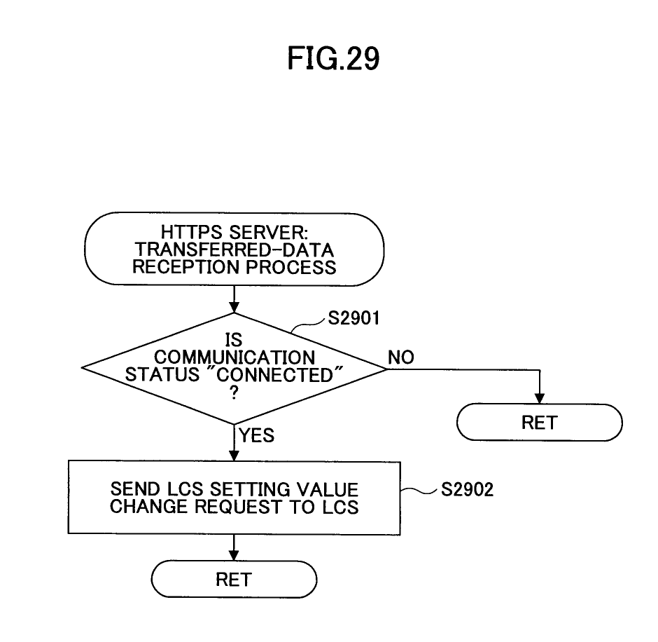

FIG. 29 is a flowchart showing an example of a transferred-data reception process. In Step S2901, the https server 210 determines whether the communication status is “connected” 2802. If the communication status is not “connected” 2802, the https server 210 ends the transferred-data reception process. If the communication status is “connected” 2802, then in Step S2902 the https server 210 sends an LCS setting value change request to the LCS 205. Thus, the transferred data reception process ends.

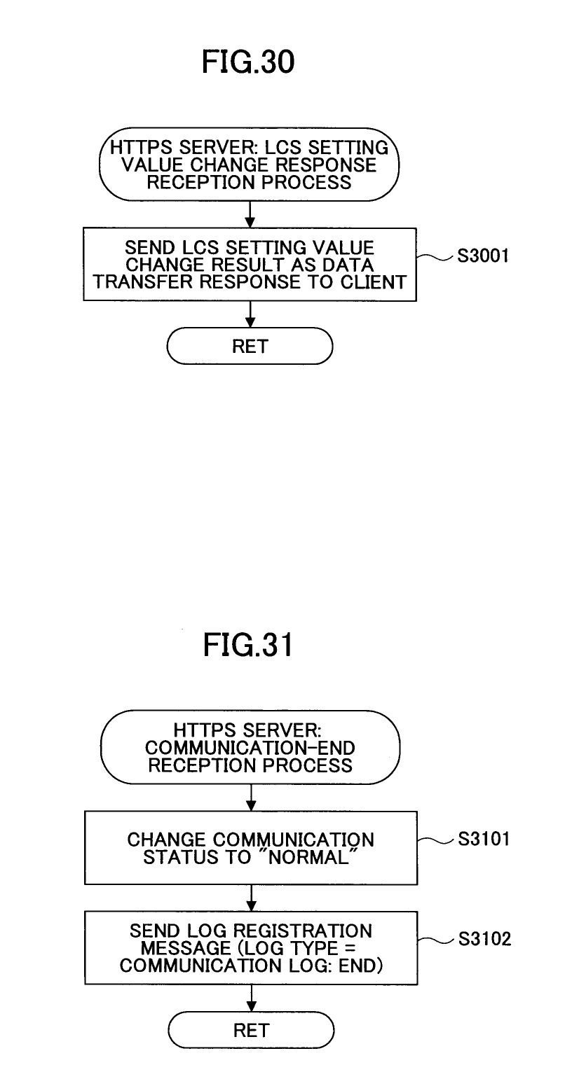

FIG. 30 is a flowchart showing an example of an LCS setting value change response reception process. In Step S3001, the https server 210 receives an LCS setting value change response from the LCS 205, and sends the result of an LCS setting value change as a data transfer response to the https client of the client PC 211. Thus, the LCS setting value change response reception process ends.

FIG. 31 is a flowchart showing an example of a communication-end reception process. In Step S3101 the https server 210 changes the communication status to “normal” 2801. Then in Step S3102 the https server 210 sends to the LCS 205 a log registration message for registering a communication log that indicates completion of the communication. Thus, the communication-end reception process ends.

The processing by the LCS 205 and the log transfer module 207 shown in FIG. 23 is described above with reference to FIGS. 10 and 16 and therefore is not described herein.

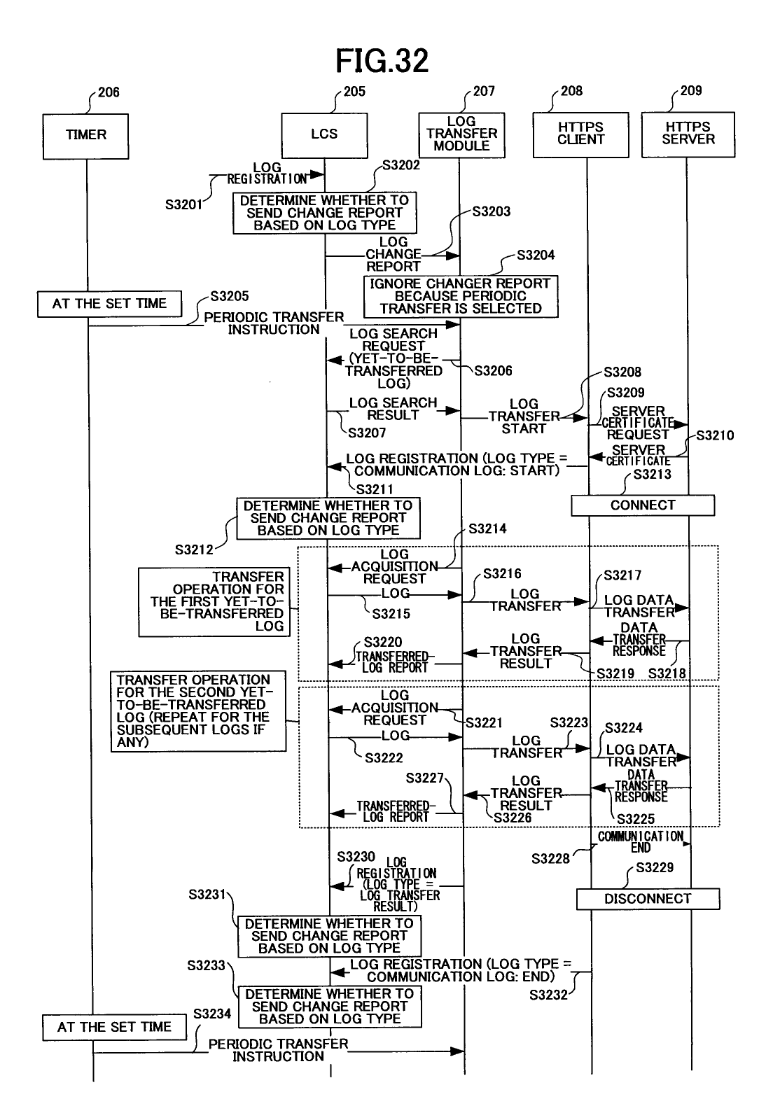

FIG. 32 is a sequence diagram showing a process of periodically transferring log information items from the device 1 to the log server 209. In Step S3201 the LCS 205 receives a log registration message and records a log information item into the HDD 15. Then in Step S3202 the LCS 205 determines whether to send a log change report based on the log type. In this example, the LCS 205 determines to send a log change report. Then in Step S3203 the LCS 205 sends a log change report to the log transfer module 207.

Then in Step S3204 because the log transfer module setting value 215 indicating periodic transfer is selected, the log transfer module 207 ignores the received log change report. When the set time comes, the timer 206 instructs the log transfer module 207 to perform a periodic transfer in Step S3205.

Then in Step S3206, the log transfer module 207 sends a log search request to the LCS 205. Then in Step S3207 the LCS 205 extracts yet-to-be transferred logs stored in the HDD 15 or the RAM 16, and sends to the log transfer module 207 the log IDs of the extracted yet-to-be-transferred logs as the log search result.

Then in Step S3208 the log transfer module 207 instructs the https client 208 to start a log transfer. Then in Step S3209 the https server 208 sends a server certificate request to the https server of the log server 209. Then in Step S3210 the https client 208 receives a server certificate from the https server of the log server 209.

Then in Step S3211 the https client 208 sends to the LCS 205 a log registration message for registering a communication log that indicates the start of a communication. The LCS 205 receives the log registration message and records a log information item into the HDD 15. Then in Step S3212 the LCS 205 determines whether to send a log change report based on the log type of the recorded log. In this example, the LCS 205 determines not to send a log change report. Then in Step S3213 the https client 208 of the device 1 is connected to the https server of the log server 209 for enabling data transfer.

Then in Step S3214 the log transfer module 207 sends a log acquisition request to the LCS 205. Then in Step S3215 the LCS 205 extracts a log information item from the HDD 15 according to the log acquisition request, and sends the extracted log information item to the log transfer module 207.

Then in Step S3216 the log transfer module 207 transfers the received log information item to the https client 208. Then in Step S3217, the https client 208 transfers the received log information item (log data) to the https server of the log server 209.

Then in Step S3218 the https server of the log server 209 sends a data transfer response to the https client 208 of the device 1. Then in Step S3219 the https client 208 sends a data transfer result to the log transfer module 207. Then in Step S3220 the log transfer module 207 sends a transferred-log report to the LCS 205.

The processing in Steps S3214 through S3220 is a transfer operation performed for the first yet-to-be-transferred log. The second and following yet-to-be-transferred logs are transferred by repeatedly performing a transfer operation in Steps S3221 through S3227 as in Steps S3214 through S3220.

After all the yet-to-be-transferred logs are transferred, the https client 208 sends a communication-end message to the https server of the log server 209 in Step S3228. Then in Step S3229 the https client 208 of the device 1 is disconnected from the https server of the log server 209.

Then in Step S3230 the log transfer module 207 sends to the LCS 205 a log registration message for registering a log-transfer-result log. The LCS 205 receives the log registration message and records a log-transfer-result log into the HDD 15. Then in Step S3231 the LCS 205 determines whether to send a log change report based on the log type of the recorded log. In this example, the LCS 205 determines not to send a log change report.

Then in Step S3232 the https client 208 sends to the LCS 205 a log registration message for registering a communication log that indicates completion of the communication. The LCS 205 receives the log registration message and records a log information item into the HDD 15. Then in Step S3233 the LCS 205 determines whether to send a log change report based on the log type. In this example, the LCS 205 determines not to send a log change report.

When the set time comes again, the timer 206 instructs the log transfer module 207 to perform a periodic transfer in Step S3234. Thus, the processing in Steps S3206 through S3233 is repeated again.

According to the sequence diagram of FIG. 32, if the transfer mode is a periodic transfer, the LCS 205 ignores sending a log change report. Therefore, it is possible to periodically transfer a log information item to the log server 209 even if the log type is one that normally causes the endless generation of log change reports.

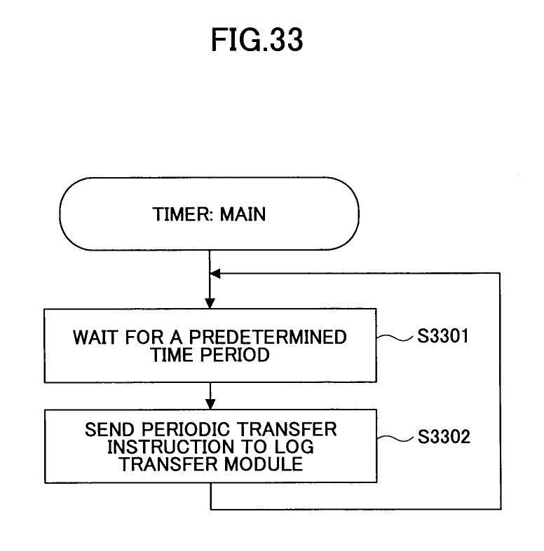

The following describes the processing by the timer 206 of FIG. 32. FIG. 33 is a flowchart showing an example of the processing by the timer 206. In Step S3301 the timer 206 waits for a predetermined time period. Although periodic transfer is performed at regular time intervals in this embodiment, periodic transfer may be performed at night with low network traffic.

Then in Step S3302 the timer 206 instructs the log transfer module 207 to perform a periodic transfer. Then the process returns to Step S3301. In this way, the timer 206 instructs the log transfer module 207 to perform a periodic transfer at regular time intervals. The processing by the LCS 205 and the log transfer module 207 shown in FIG. 32 is described above with reference to FIGS. 10 and 16 and therefore is not described herein.

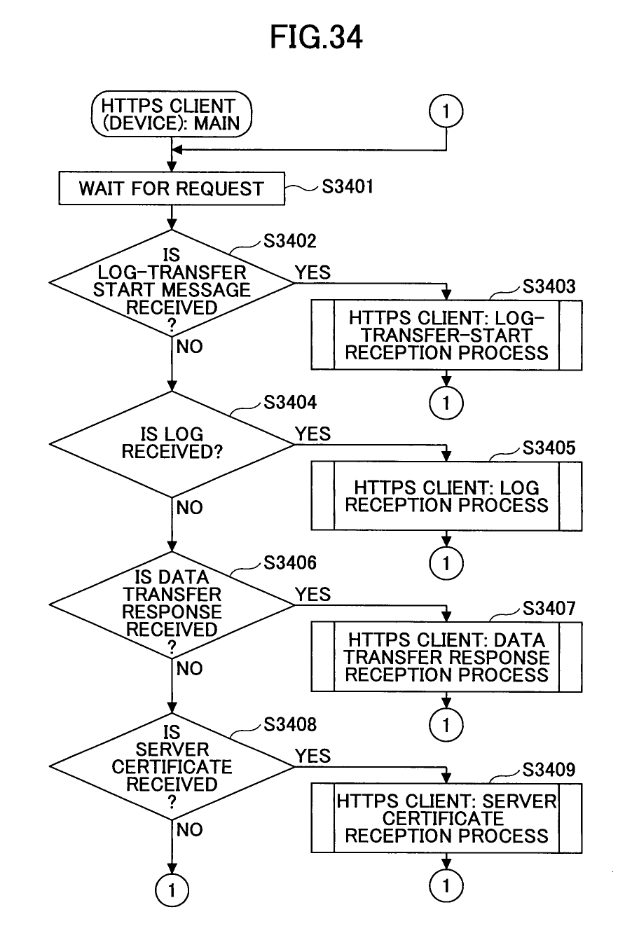

The following describes the processing by the https client 208 of FIG. 32. FIG. 34 is a flowchart showing an example of the processing by the https client 208 of the device 1. In Step S3401 the https client 208 waits for a request.

If a request is received, then in Step S3402 the https client 208 determines whether the received request contains a log-transfer-start message. If the received request contains a log-transfer-start message, then in Step S3403 the https client 208 performs a log-transfer-start reception process described below.

If in Step S3402 the received request does not contain a log-transfer-start message, then in Step S3404 the https client 208 determines whether the received request contains a log. If the received request contains a log, then in Step S3405 the https client 208 performs a log reception process described below.

If in Step S3404 the received request does not contain a log, then in Step S3406 the https client 208 determines whether the received request contains a data transfer response. If the received request contains a data transfer response, then in Step S3407 the https client 208 performs a data transfer response reception process described below.

If in Step S3406 the received request does not contain a data transfer response, then in Step S3408 the https client 208 determines whether the received request contains a server certificate. If the received request contains a server certificate, then in Step S3409 the https client 208 performs a server certificate reception process described below. If the received request does not contain a server certificate, the process returns to Step S3401.

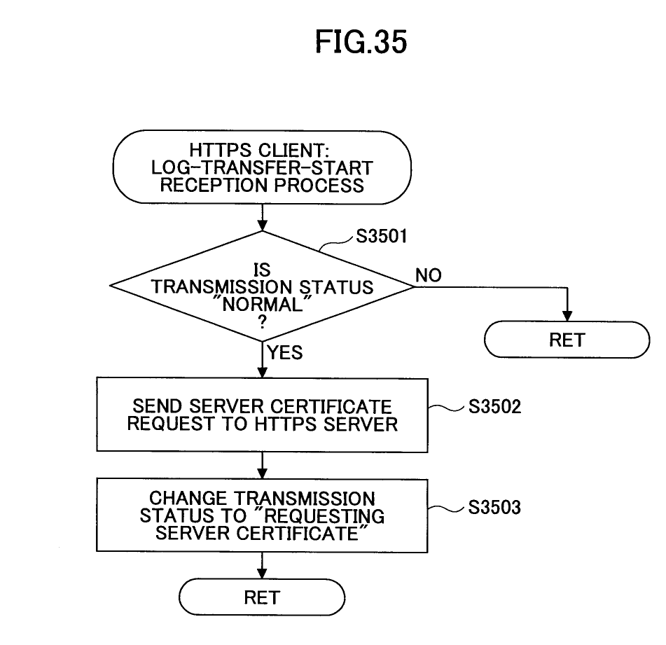

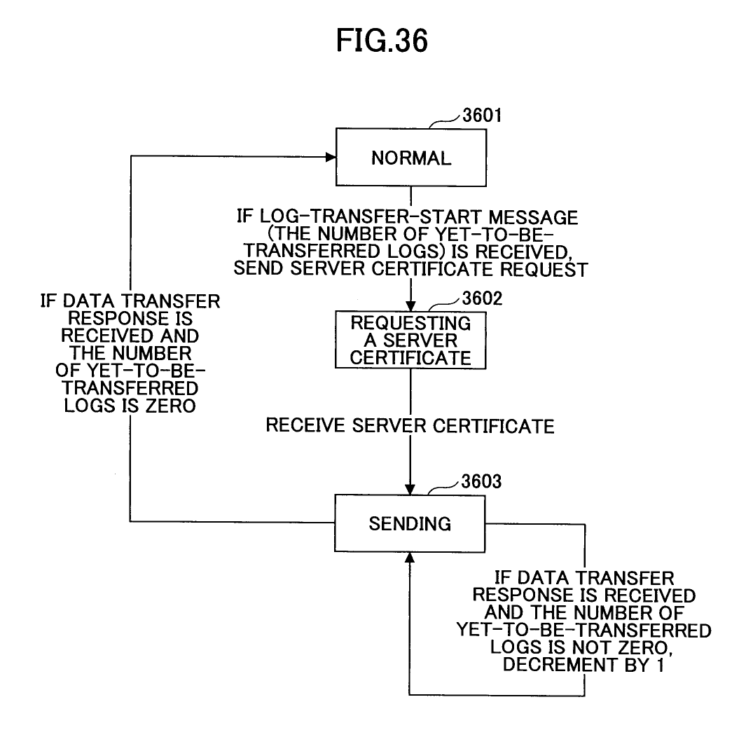

FIG. 35 is a flowchart showing an example of a log-transfer-start reception process. In Step S3501 the https client 208 determines whether the communication status is “normal” 3601. FIG. 36 is a chart showing a transition of a transmission status of the https client 208.

If the transmission status is not “normal” 3601, the https client 208 ends the log-transfer-start reception process. If the transmission status is “normal” 3601, then in Step S3502 the https client 208 sends a server certificate request to the https server of the log server 209. Then in Step S3503 the https client 208 changes the transmission status to “requesting a server certificate” 3602. Thus, the log-transfer-start reception process ends.

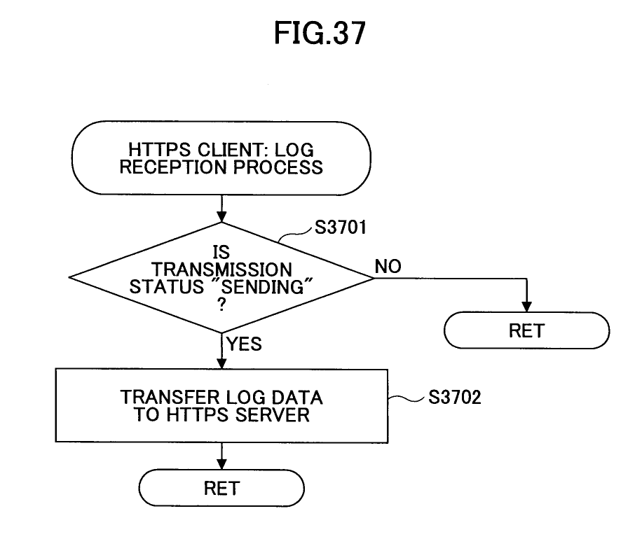

FIG. 37 is a flowchart showing an example of a log reception process. In Step S3701 the https client 208 determines whether the transmission status is “sending” 3603. If the transmission status is not “sending” 3603, the https client 208 ends the log reception process.

If in Step S3701 the transmission status is “sending” 3603, then in Step S3702 the https client 208 transfers log data to the https server of the log server 209. Thus, the log reception process ends.

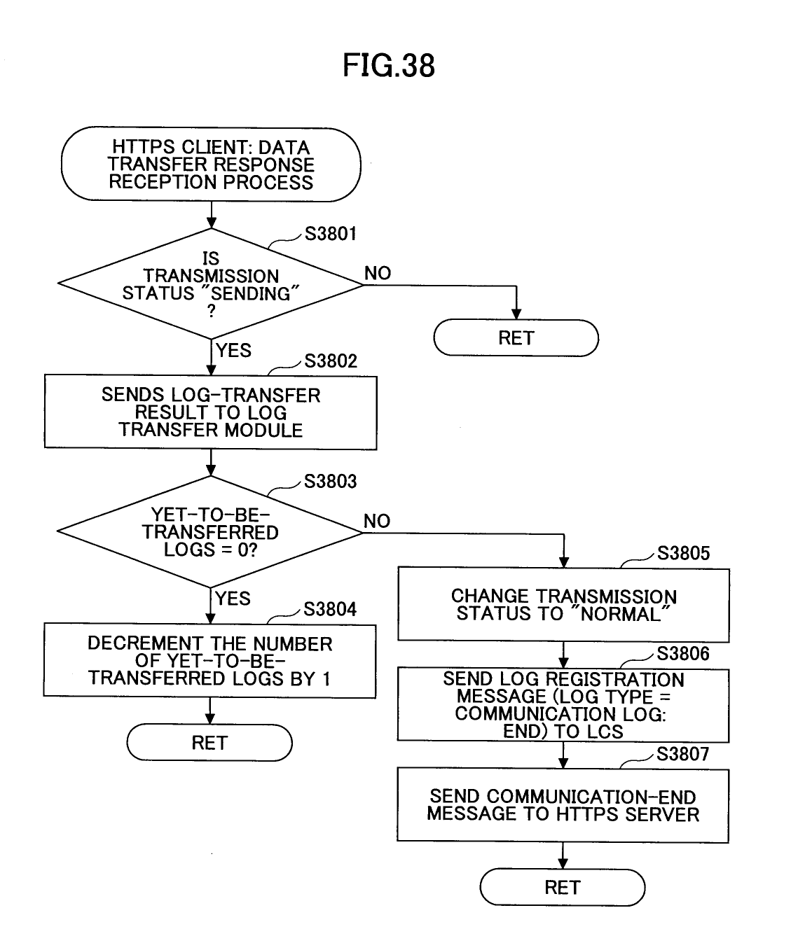

FIG. 38 is a flowchart showing an example of a data transfer response reception process. In Step S3801 the https client 208 determines whether the transmission status is “sending” 3603.

If the transmission status is not “sending” 3603, the https client 208 ends the data transfer response reception process. If the transmission status is “sending” 3603, then in Step S3802 the https client 208 sends a log transfer result to the log transfer module 207.

Then in Step S3803 the https client 208 determines whether the number of the yet-to-be-transferred logs is “0”. If the number of yet-to-be-transferred logs is “0”, then in Step S3805 the https client 208 changes the transmission status to “normal” 3601.

Then in Step S3806 the https client 208 sends to the LCS 205 a log registration message for registering a communication log that indicates completion of a communication. Then in Step S3807 the https client 208 sends a communication-end message. Thus, the log reception process ends.

If in Step S3803 the number of yet-to-be-transferred logs is not “0”, then in Step S3804 the https client 208 decrements by 1 the number of yet-to-be-transferred logs contained in the log-transfer-start message. Thus, the log reception process ends.

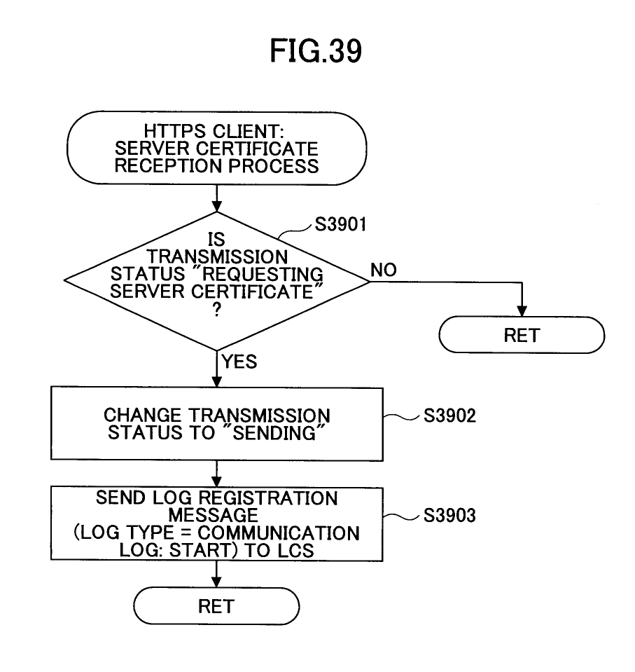

FIG. 39 is a flowchart showing an example of a server certificate reception process. In Step S3901 the https client 208 determines whether the transmission status is “requesting a server certificate” 3602. If the transmission status is not “requesting a server certificate” 3602, the https client 208 ends the server certificate reception process.

If the transmission status is “requesting a server certificate” 3602, then in Step S3902 the https client 208 changes the transmission status to “sending” 3603. Then in Step S3903 the https client 208 sends to the LCS 205 a log registration message for registering a communication log that indicates the start of a communication. Thus, the server certificate reception process ends.

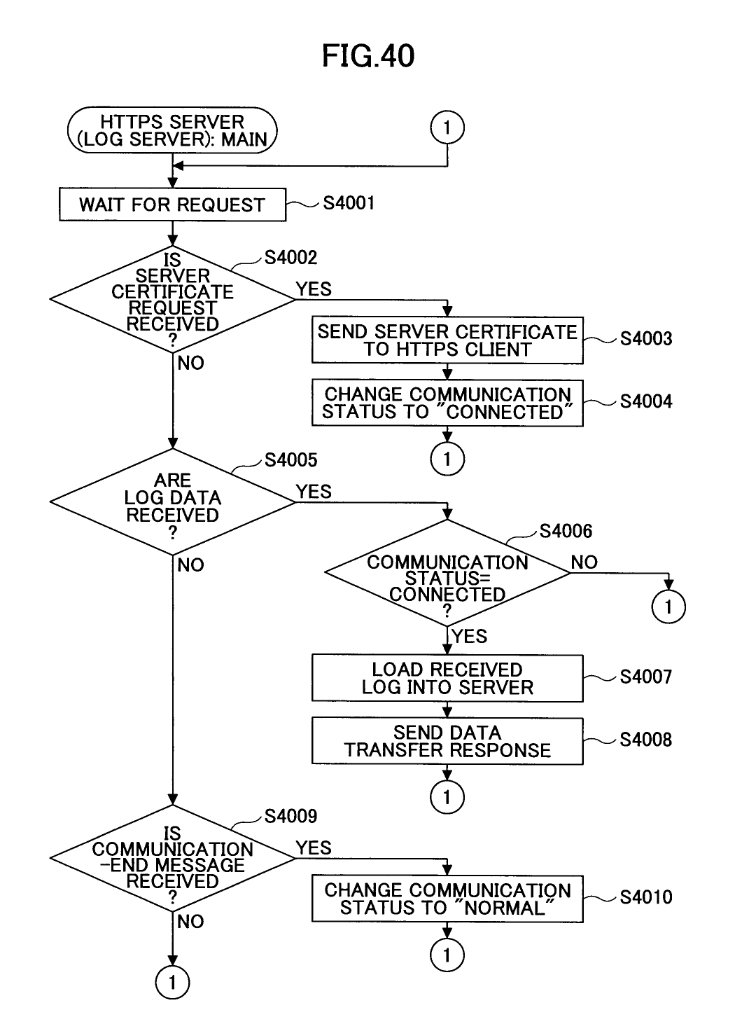

The processing by the https server of the log server 209 of FIG. 32 is described below in greater detail. FIG. 40 is a flowchart showing an example of the processing by the https server of the log server 209. In Step S4001 the https server waits for a request. If a request is received, then in Step S4002 the https server determines whether the received request contains a server certificate request.

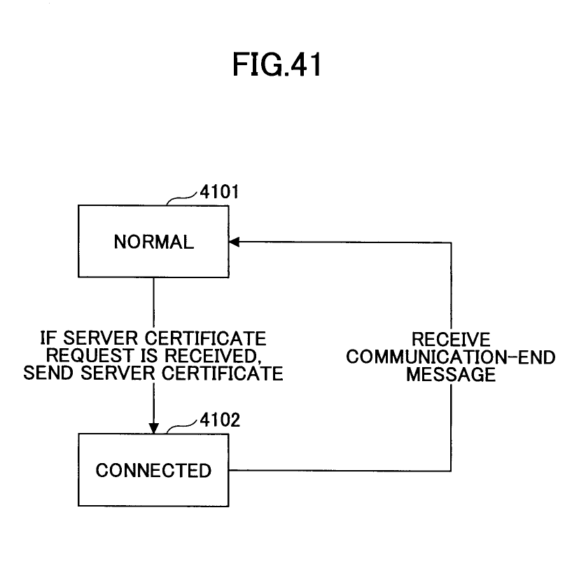

If the received request contains a server certificate request, then in Step S4003 the https server sends a server certificate to the https client 208. Then in Step S4004 the https server changes the communication status to “connected” 4102. Then the process returns to Step S4001. FIG. 41 is a chart showing a transition of the communication status of the https server.

If the received request does not contain a server certificate request, then in Step S4005 the https server determines whether the received request contains log data. If the received request contains log data, then in Step S4006 the https server determines whether the communication status is “connected” 4102.

If the communication status is “connected” 4102, then in Step S4007 the https server loads the received log information item into the log server 209. Then in Step S4008 the https server sends a data transfer response. Then the process returns to Step S4001. If the communication status is not “connected” 4102, then the process returns to Step S4001.

If the received request does not contain log data, then in Step S4009 the https server determines whether the received request contains a communication-end message. If the received request does not contain a communication-end message, the process returns to Step S4001. If the received request contains a communication-end message, then in Step S4010 the https server changes the transmission status to “normal” 4101. Then the process returns to Step S4001.

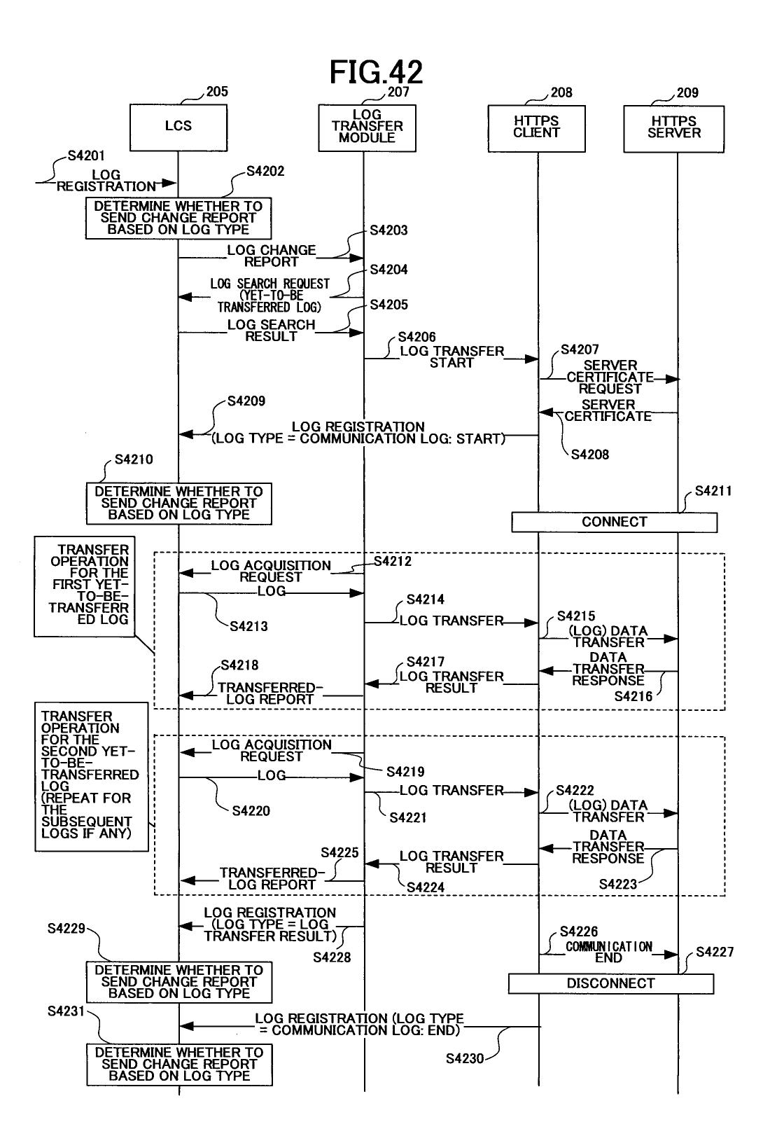

FIG. 42 is a sequence diagram showing a process of sequentially transferring log information items from the device 1 to the log server 209. In Step S4201 the LCS 205 receives a log registration message and records a log information item into the HDD 15. Then in Step S4202 the LCS 205 determines whether to send a log change report based on the log type of the recorded log. In this example, the LCS 205 determines to send a log change report. Then in Step S4203 the LCS 205 sends a log change report to the log transfer module 207.

Then in Step S4204 the log transfer module 207 sends a log search request to the LCS 205. Then in Step S4205 the LCS 205 extracts yet-to-be-transferred logs from the HDD 15 or the RAM 16, and sends to the log transfer module 207 the log IDs of the extracted yet-to-be-transferred logs as the log search result.

Then in Step S4206 the log transfer module 207 instructs the https client 208 to start a log transfer. Then in Step S4207 the https client 208 sends a server certificate to the https server of the log server 209. Then in Step S4208 the https client 208 receives a server certificate from the https server of the log server 209.

Then in Step S4209, the https client 208 sends to the LCS 205 a log registration message for registering a communication log that indicates the start of a communication. The LCS 205 receives the log registration message and records a log information item into the HDD 15. Then in Step S4210 the LCS 205 determines whether to send a log change report based on the log type. In this example, the LCS 205 determines not to send a log change report.

Then in Step S4211 the https client 208 of the device 1 is connected to the https server of the log server 209 for enabling data transfer.

Then in Step S4212 the log transfer module 207 sends a log acquisition request to the LCS 205. Then in Step S4213 the LCS 205 extracts a log information item from the HDD 15 according to the log acquisition request, and sends the extracted log information item to the log transfer module 207.

Then in Step S4214 the log transfer module 207 transfers the received log information item to the https client 208. Then in Step S4215 the https client 208 transfers the received log information item (log data) to the https server of the log server 209.

Then in Step S4216 the https server of the log server 209 sends a data transfer response to the https client 208 of the device 1. Then in Step S4217 the https client 208 sends a data transfer result to the log transfer module 207. Then in Step S4218 the log transfer module 207 sends a transferred-log report to the LCS 205.

The processing in Steps S4212 through S4218 is a transfer operation performed for the first yet-to-be-transferred log. The second and following yet-to-be-transferred logs are transferred by repeatedly performing a transfer operation in Steps S4219 through S4225 as in Steps S4212 through S4218.

After all the yet-to-be-transferred logs are transferred, the https client 208 sends a communication-end message to the https server of the log server 209 in Step S4226. Then in Step S4227 the https client 208 of the device 1 is disconnected from the https server of the log server 209.

Then in Step S4228 the log transfer module 207 sends to the LCS 205 a log registration message for registering a log-transfer-result log. The LCS 205 receives the log registration message and records the log-transfer-result log into the HDD 15. In Step S4229 the LCS 205 determines whether to send a log change report based on the log type of the recorded log. In this example, the LCS 205 determines not to send a log change report.

Then in Step S4230 the https client 208 sends to the LCS 205 a log registration message for registering a communication log that indicates completion of the communication. The LCS 205 receives the log registration message and records a log information item into the HDD 15. Then in Step S4231 the LCS 205 determines whether to send a log change report based on the log type of the recorded log. In this example, the LCS 205 determines not to send a log change report.

In the processing shown in the sequence diagram of FIG. 42, if the log type of a recorded log information item is one that causes endless generation of log change reports, the LCS 205 determines not to send a log change report, thereby preventing entering into an endless loop.

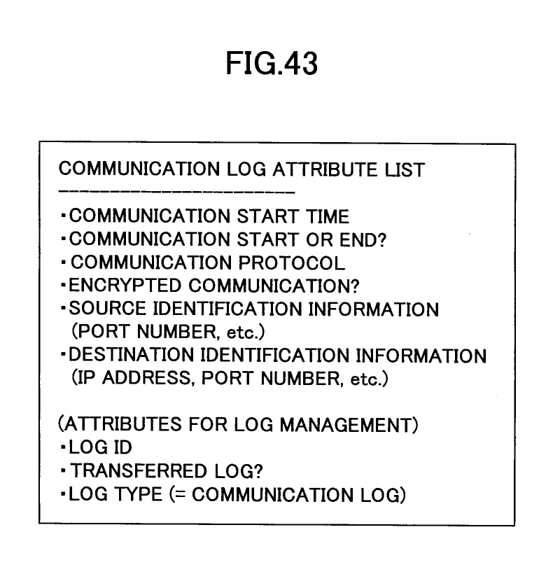

The following is a description of the terms used in the above. FIGS. 43 through 46 are conceptual diagrams each used to explain attributes of a log information item. FIG. 43 shows a list of attributes of a communication log as an example of a log information item. These communication log attributes of FIG. 43 are recorded in, e.g., an XML format in the log server 209.

The attribute “log ID” in the communication log attribute list is uniquely assigned to each log generated in a single device. In the log server 209, a device identifier is added to make the log ID unique.

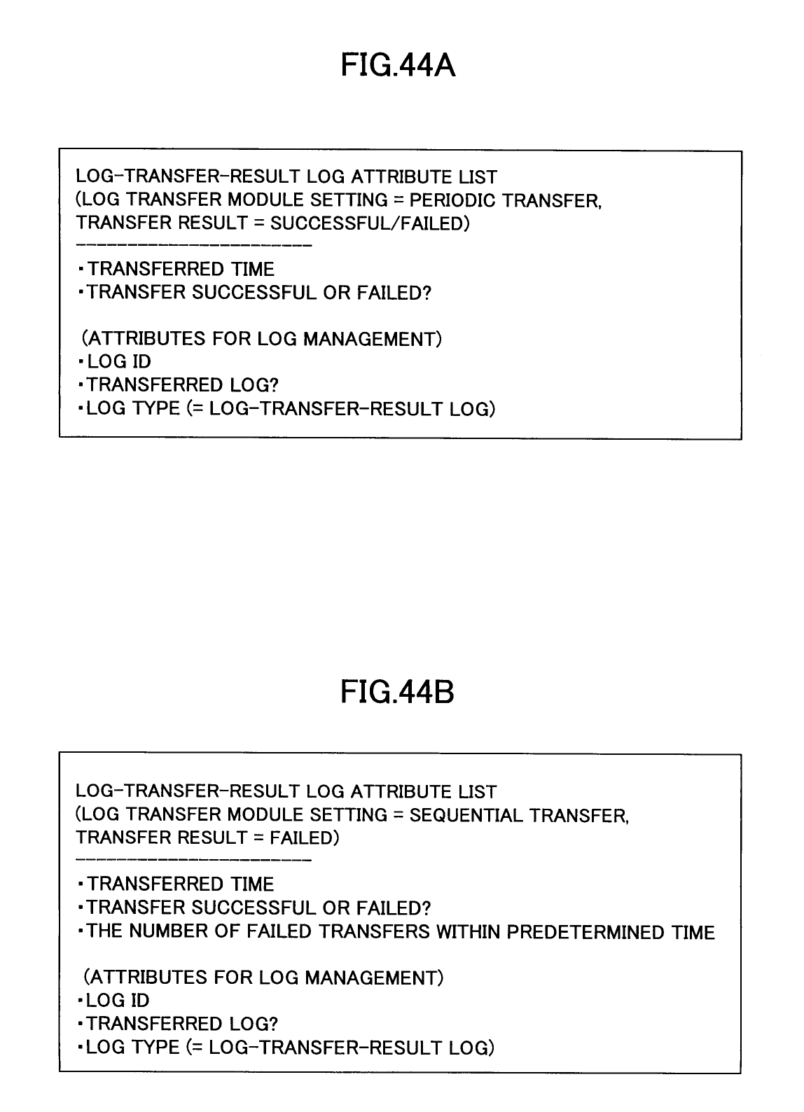

FIGS. 44A and 44B each show a list of attributes of a log-transfer-result log as an example of a log information item. These log-transfer-result log attributes of FIGS. 44A and 44B are recorded in, e.g., an XML format in the log server 209. The log-transfer-result log attribute list of FIG. 44A is used for the transfer mode “periodic transfer”. The log-transfer-result log attribute list of FIG. 44B is used for the transfer mode “sequential transfer”.

When the transfer mode is “periodic transfer”, whether the transfer is successful or failed is recorded in the log. On the other hand, when the transfer mode is “sequential transfer”, a failed transfer is additionally recorded in the log. If the transfer has failed, the number of transfer failures within a predetermined time period is counted and registered in the log.

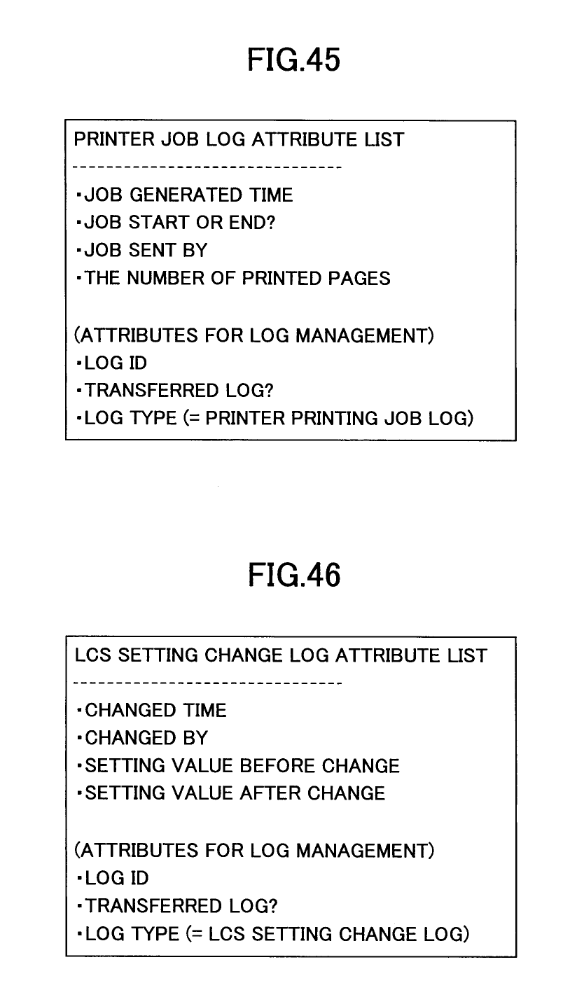

FIG. 45 shows a list of attributes of a printer job log as an example of a log information item. These printer job log attributes of FIG. 45 are recorded in, e.g., an XML format in the log server 209. FIG. 46 shows a list of attributes of an LCS setting change log as an example of a log information item. These LCS setting value log attributes of FIG. 46 are recorded in, e.g., an XML format in the log server 209.

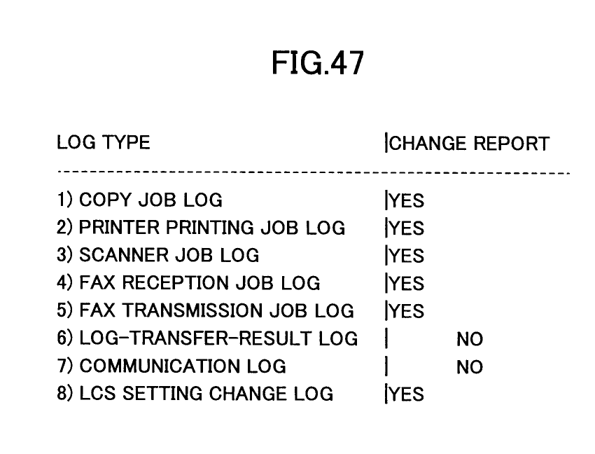

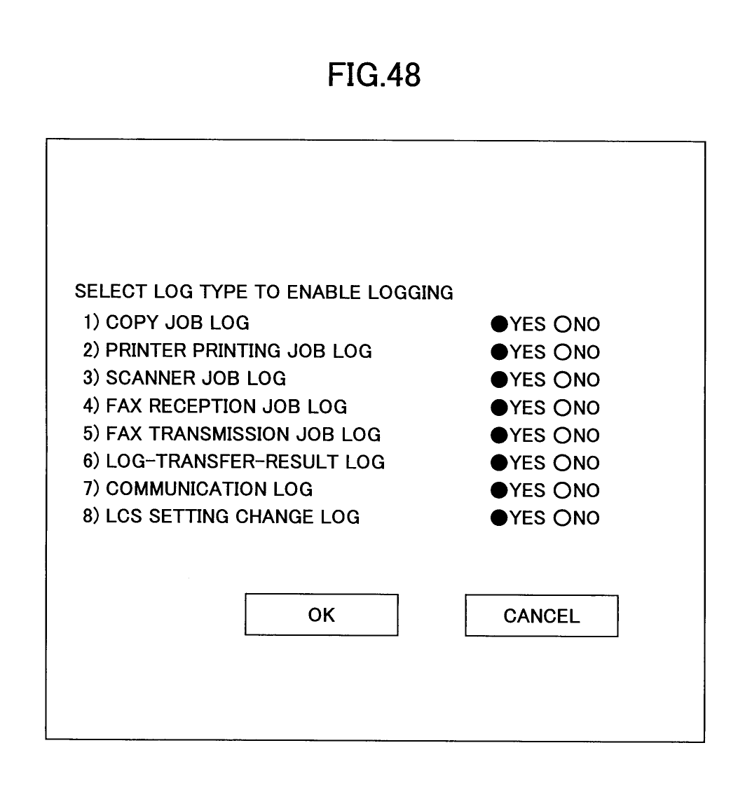

FIG. 47 is a table showing log types and log change report and settings specifying whether to issue a log change report. As shown in FIG. 47, whether to issue a log change report is determined base on the log type. FIG. 48 is a conceptual diagram showing a Web screen for LCS setting value change. On the Web screen of FIG. 48, ON/OFF of logging is selected for each log type.

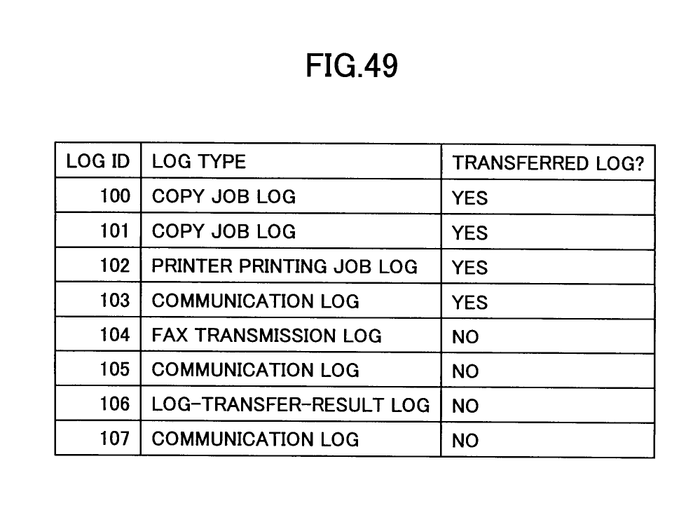

FIG. 49 shows a table of log management attributes. As shown in FIG. 49, the generated log information items are managed with a log ID and the value of “transferred log?” in the log management attribute table. In FIG. 49, as the value of “transferred log?”, either “NO” indicating that the log is waiting to be transferred or “YES” indicating that the log has been transferred is selected. The communication log as used in the above embodiment of the present invention indicates a record of communication via the LAN 4.

The present invention is not limited to the above-described embodiments, and variations and modifications may be made without departing from the scope of the invention.

The present application is based on Japanese Priority Application No. 2006-247242 filed on Sep. 12, 2006, and Japanese Priority Application No. 2007-123630 filed on May 8, 2007, with the Japanese Patent Office, the entire contents of which are hereby incorporated by reference.

What is claimed is:

1. A log transfer device that transfers a log information item to an external device connected via a predetermined network, the log transfer device comprising:
a storage unit that stores the log information item;
a log control unit that, if the log information item is not one that causes generation of another log information item due to transfer to the external device, sends a log change report; and
a log transfer unit that, in response to reception of the log change report, reads out the log information item from the storage unit and transfers the read log information item to the external device.

2. The log transfer device as claimed in claim 1,
wherein, if the log information item is one that causes generation of another log information item due to transfer to the external device, the log control unit maintains the log information item in the storage unit and does not send a log change report; and
in response to reception of the log change report, the log transfer unit reads out, from the storage unit, the log information item that causes generation of another log information item due to transfer to the external device, and transfers the read log information item to the external device.

3. The log transfer device as claimed in claim 1, wherein the log control unit is provided with a setting specifying whether to send the log change report based on a type of the log information item, and determines whether to send the log change report according to the setting.

4. The log transfer device as claimed in claim 1, wherein the log control unit is provided with a setting specifying whether to store the log information item into the storage unit based on a type of the log information item, and determines whether to store the log information item into the storage unit according to the setting.

5. The log transfer device as claimed in claim 3, wherein the setting specifying whether to send the log change report is made by a client connected to the log transfer device via the network.

6. The log transfer device as claimed in claim 4, wherein the setting specifying whether to store the log information item into the storage unit is made by a client connected to the log transfer device via the network.

7. The log transfer device as claimed in claim 1, wherein said other log information item to be generated due to transfer to the external device is a communication log or a log-transfer-result log.

8. A computer-readable medium storing a log transfer program for transferring a log information item to an external device connected via a predetermined network, the program causing a computer to function as:
a storage unit that stores the log information item;
a log control unit that, if the log information item is not one that causes generation of another log information item due to transfer to the external device, sends a log change report; and
a log transfer unit that, in response to reception of the log change report, reads out the log information item from the storage unit and transfers the read log information item to the external device.

9. The computer-readable medium storing the log transfer program as claimed in claim 8,
wherein, if the log information item is one that causes generation of another log information item due to transfer to the external device, the log control unit maintains the log information item in the storage unit and does not send a log change report; and
in response to reception of the log change report, the log transfer unit reads out, from the storage unit, the log information item that causes generation of another log information item due to transfer to the external device, and transfers the read log information item to the external device.

10. The computer-readable medium storing the log transfer program as claimed in claim 8, wherein the log control unit is provided with a setting specifying whether to send the log change report based on a type of the log information item, and determines whether to send the log change report according to the setting.

11. The computer-readable medium storing the log transfer program as claimed in claim 8, wherein the log control unit is provided with a setting specifying whether to store the log information item into the storage unit based on a type of the log information item, and determines whether to store the log information item into the storage unit according to the setting.

12. The computer-readable medium storing the log transfer program as claimed in claim 10, wherein the setting specifying whether to send the log change report is made by a client connected via the network.

13. The computer-readable medium storing the log transfer program as claimed in claim 11, wherein the setting specifying whether to store the log information item into the storage unit is made by a client connected via the network.

14. The computer-readable medium storing the log transfer program as claimed in claim 8, wherein said another log information item to be generated due to transfer to the external device is a communication log or a log-transfer-result log.
